(19) United States
(12) Patent Application Publication
(10) Pub. No.: US 2026/0032698 A1
(43) Pub. Date: Jan. 29, 2026

(54) CAPACITY ENHANCEMENT FOR A SIDELINK FEEDBACK CHANNEL

(71) Applicant: QUALCOMM Incorporated, San Diego, CA (US)

(72) Inventors: Siyi CHEN, Beijing (CN); Jing SUN, San Diego, CA (US); Chih-Hao LIU, San Diego, CA (US); Xiaoxia ZHANG, San Diego, CA (US); Giovanni CHISCI, San Diego, CA (US); Changlong XU, Beijing (CN); Shaozhen GUO, Beijing (CN); Luanxia YANG, Beijing (CN); Hao XU, Beijing (CN)

(21) Appl. No.: 18/874,021

(22) PCT Filed: Aug. 11, 2022
(86) PCT No.: PCT/CN2022/111733

§ 371 Date: Dec. 11, 2024

(51) Int. Cl. H04W 72/25; H04J 13/00; H04J 13/18

(52) U.S. Cl. CPC H04W 72/25; H04J 13/0007; H04J 13/004; H04J 13/18; H04J 2013/0037

(57) ABSTRACT

Various aspects of the present disclosure generally relate to wireless communication. In some aspects, a user equipment (UE) may receive a configuration of a feedback resource associated with a sidelink feedback channel, wherein the feedback resource is associated with an eight-level code division multiplexing (CDM) scheme. The UE may transmit a feedback communication associated with a sidelink data communication using the feedback resource, wherein transmitting the feedback communication is based at least in part on using the eight-level CDM scheme to generate the feedback communication. Numerous other aspects are described.

### FIELD OF THE DISCLOSURE

Aspects of the present disclosure generally relate to wireless communication and to techniques and apparatuses for capacity enhancement for a sidelink feedback channel.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration of a feedback resource associated with a sidelink feedback channel, wherein the feedback resource is associated with an eight-level code division multiplexing (CDM) scheme. The method may include transmitting a feedback communication associated with a sidelink data communication using the feedback resource, wherein transmitting the feedback communication is based at least in part on using the eight-level CDM scheme to generate the feedback communication.

Some aspects described herein relate to a method of wireless communication performed by a UE. The method may include receiving a configuration of a feedback resource associated with a sidelink feedback channel, wherein the feedback resource is associated with multiple sub-physical-resource-block (sub-PRB) interlaces. The method may include transmitting a feedback communication associated with a sidelink data communication using the feedback resource, wherein transmitting the feedback communication is based at least in part on transmitting feedback information in a sub-PRB interlace, of the multiple sub-PRB interlaces.

Some aspects described herein relate to a method of wireless communication performed by a UE. The method may include receiving a configuration of a feedback resource associated with a sidelink feedback channel, wherein the feedback resource is associated with multiple partial interlace groups. The method may include transmitting a feedback communication associated with a sidelink data communication using the feedback resource, wherein transmitting the feedback communication is based at least in part on transmitting feedback information in a first partial interlace group, of the multiple partial interlace groups, and generating the feedback communication based at least in part on using a time domain orthogonal cover code (TD-OCC) scheme.

Some aspects described herein relate to a UE for wireless communication. The user equipment may include a memory and one or more processors coupled to the memory. The one or more processors may be configured to receive a configuration of a feedback resource associated with a sidelink feedback channel, wherein the feedback resource is associated with an eight-level CDM scheme. The one or more processors may be configured to transmit a feedback communication associated with a sidelink data communication using the feedback resource, wherein transmitting the feedback communication is based at least in part on using the eight-level CDM scheme to generate the feedback communication.

Some aspects described herein relate to a UE for wireless communication. The UE may include a memory and one or more processors coupled to the memory. The one or more processors may be configured to receive a configuration of a feedback resource associated with a sidelink feedback channel, wherein the feedback resource is associated with multiple sub-PRB interlaces. The one or more processors may be configured to transmit a feedback communication associated with a sidelink data communication using the feedback resource, wherein transmitting the feedback communication is based at least in part on transmitting feedback information in a sub-PRB interlace, of the multiple sub-PRB interlaces.

Some aspects described herein relate to a UE for wireless communication. The UE may include a memory and one or more processors coupled to the memory. The one or more processors may be configured to receive a configuration of a feedback resource associated with a sidelink feedback channel, wherein the feedback resource is associated with multiple partial interlace groups. The one or more processors may be configured to transmit a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme.

Some aspects described herein relate to a non-transitory computer-readable medium that stores a set of instructions for wireless communication by a UE. The set of instructions, when executed by one or more processors of the UE, may cause the UE to receive a configuration of a feedback resource associated with a sidelink feedback channel, wherein the feedback resource is associated with an eight-level CDM scheme. The set of instructions, when executed by one or more processors of the UE, may cause the UE to transmit a feedback communication associated with a sidelink data communication using the feedback resource, wherein transmitting the feedback communication is based at least in part on using the eight-level CDM scheme to generate the feedback communication.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive a configuration of a feedback resource associated with a sidelink feedback channel, wherein the feedback resource is associated with multiple sub-PRB interlaces. The set of instructions, when executed by one or more processors of the one or more instructions that, when executed by one or more processors of an UE, may cause the one or more instructions that, when executed by one or more processors of an UE to transmit a feedback communication associated with a sidelink data communication using the feedback resource, wherein transmitting the feedback communication is based at least in part on transmitting feedback information in a sub-PRB interlace, of the multiple sub-PRB interlaces.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive a configuration of a feedback resource associated with a sidelink feedback channel, wherein the feedback resource is associated with multiple partial interlace groups. The set of instructions, when executed by one or more processors of the one or more instructions that, when executed by one or more processors of an UE, may cause the one or more instructions that, when executed by one or more processors of an UE to transmit a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme.

Some aspects described herein relate to an apparatus for wireless communication. The apparatus may include means for receiving a configuration of a feedback resource associated with a sidelink feedback channel, wherein the feedback resource is associated with an eight-level CDM scheme. The apparatus may include means for transmitting a feedback communication associated with a sidelink data communication using the feedback resource, wherein transmitting the feedback communication is based at least in part on using the eight-level CDM scheme to generate the feedback communication.

Some aspects described herein relate to an apparatus for wireless communication. The apparatus may include means for receiving a configuration of a feedback resource associated with a sidelink feedback channel, wherein the feedback resource is associated with multiple sub-PRB interlaces. The apparatus may include means for transmitting a feedback communication associated with a sidelink data communication using the feedback resource, wherein transmitting the feedback communication is based at least in part on transmitting feedback information in a sub-PRB interlace, of the multiple sub-PRB interlaces.

Some aspects described herein relate to an apparatus for wireless communication. The apparatus may include means for receiving a configuration of a feedback resource associated with a sidelink feedback channel, wherein the feedback resource is associated with multiple partial interlace groups. The apparatus may include means for transmitting a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of resources associated with a physical sidelink feedback channel (PSFCH), in accordance with the present disclosure.

FIG. 7 is a diagram illustrating an example of resources associated with an interlaced PSFCH waveform, in accordance with the present disclosure.

FIG. 8 is a diagram illustrating an example of a PSFCH format 2 communication structure, in accordance with the present disclosure.

FIG. 9 is a diagram illustrating an example of a partial interlace waveform associated with a PSFCH, in accordance with the present disclosure.

FIG. 10 is a diagram of an example associated with a feedback resource associated with an eight-level code division multiplexing (CDM) scheme, in accordance with the present disclosure.

FIGS. 11A-11C are diagrams illustrating an example associated with a feedback resource associated with an eight-level CDM scheme, in accordance with the present disclosure.

FIG. 12 is a diagram of an example associated with a feedback resource associated with a sub-physical-resource-block (sub-PRB) interlace, in accordance with the present disclosure.

FIGS. 13A-13B are diagrams illustrating an example associated with a feedback resource associated with a sub-PRB interlace, in accordance with the present disclosure.

FIG. 14 is a diagram of an example associated with a feedback resource associated with a partial interlace group, in accordance with the present disclosure.

FIG. 15 is a diagram illustrating an example associated with a feedback resource associated with a partial interlace, in accordance with the present disclosure.

FIG. 16 is a diagram illustrating an example process performed, for example, by a UE, in accordance with the present disclosure.

FIG. 17 is a diagram illustrating an example process performed, for example, by an UE, in accordance with the present disclosure.

FIG. 18 is a diagram illustrating an example process performed, for example, by an UE, in accordance with the present disclosure.

FIG. 19 is a diagram of an example apparatus for wireless communication, in accordance with the present disclosure.

FIG. 20 is a diagram of an example apparatus for wireless communication, in accordance with the present disclosure.

FIG. 21 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

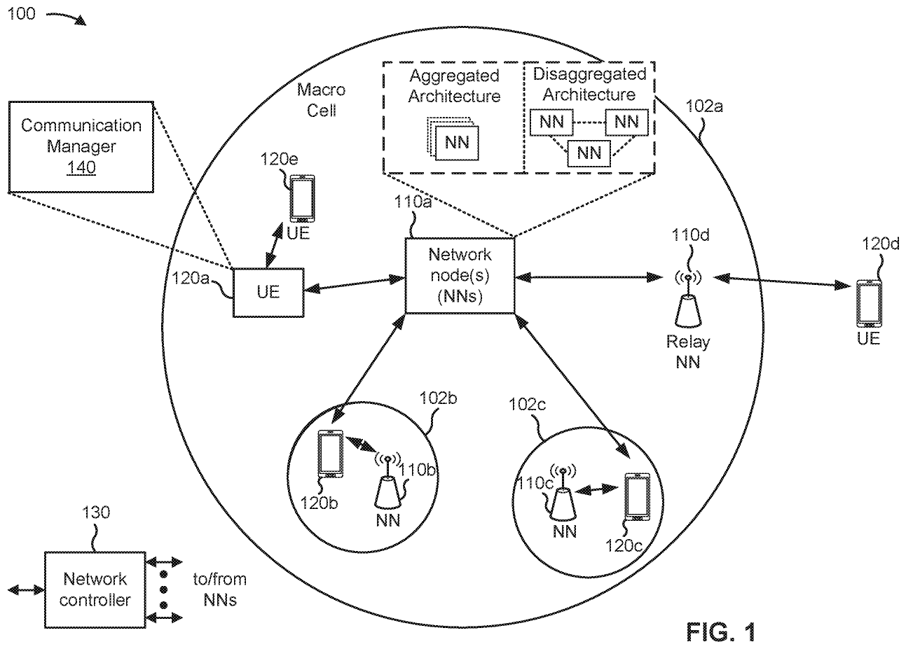

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a feedback resource associated with a sidelink feedback channel, wherein the feedback resource is associated with an eight-level code division multiplexing (CDM) scheme; and transmit a feedback communication associated with a sidelink data communication using the feedback resource, wherein transmitting the feedback communication is based at least in part on using the eight-level CDM scheme to generate the feedback communication. In some other aspects, the communication manager 140 may receive a configuration of a feedback resource associated with a sidelink feedback channel, wherein the feedback resource is associated with multiple sub-physical-resource-block (sub-PRB) interlaces; and transmit a feedback communication associated with a sidelink data communication using the feedback resource, wherein transmitting the feedback communication is based at least in part on transmitting feedback information in a sub-PRB interlace, of the multiple sub-PRB interlaces. In some other aspects, the communication manager 140 may receive a configuration of a feedback resource associated with a sidelink feedback channel, wherein the feedback resource is associated with multiple partial interlace groups; and transmit a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a time domain orthogonal cover code (TD-OCC) scheme. Additionally, or alternatively, the communication manager 140 may perform one or more other operations described herein.

As indicated above, FIG. 1 is provided as an example. Other examples may differ from what is described with regard to FIG. 1.

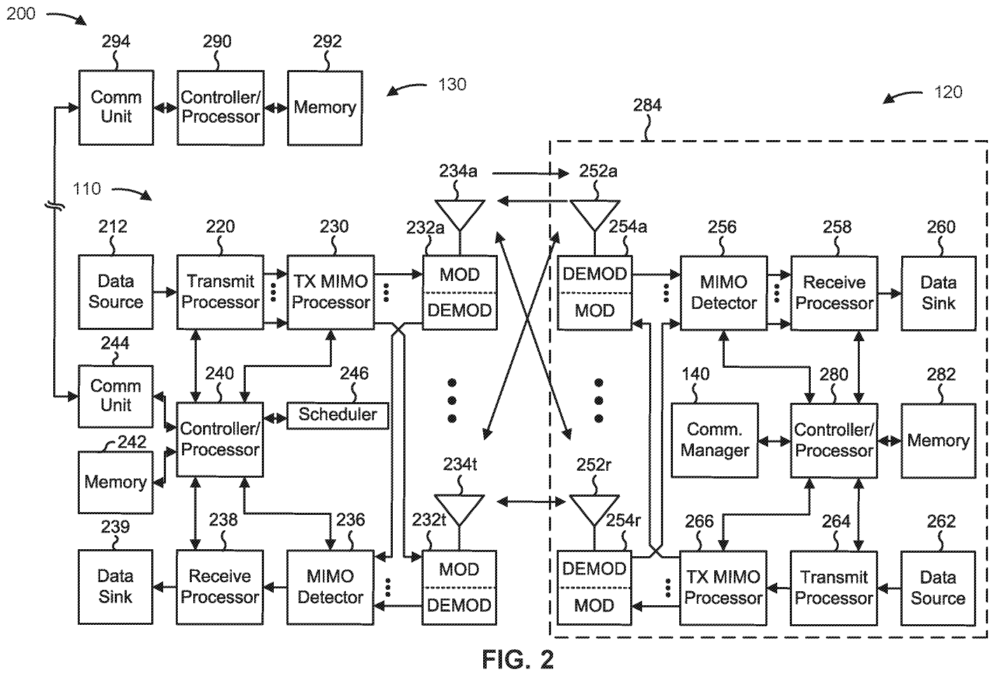

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

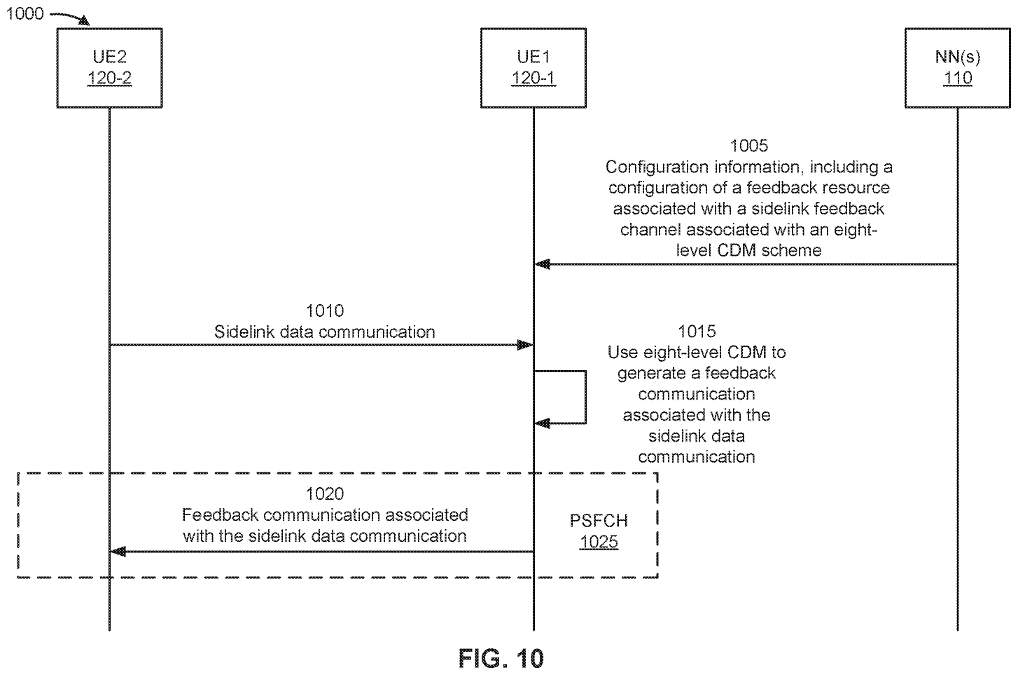

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 10-21).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 10-21).

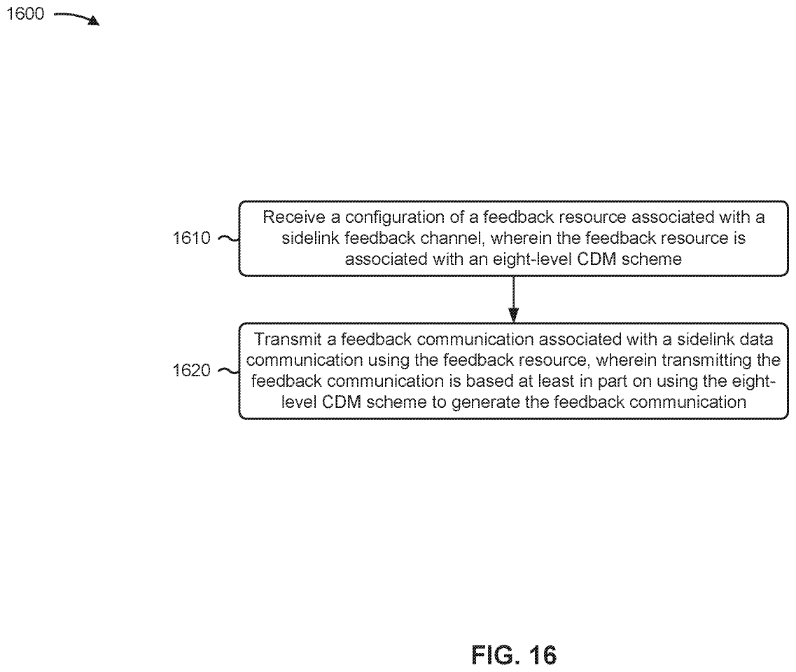

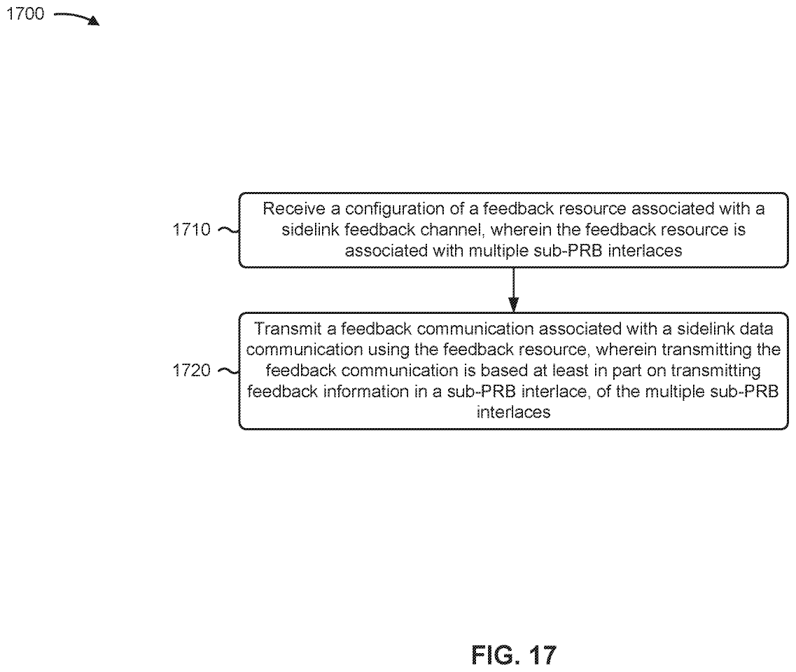

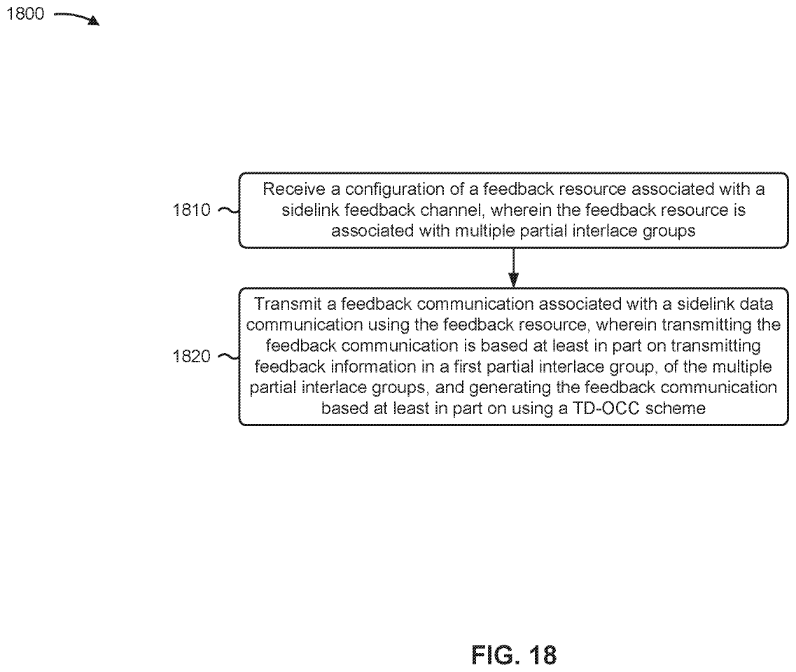

The controller/processor 240 of the network node 110, the controller/processor 280 of the UE 120, and/or any other component(s) of FIG. 2 may perform one or more techniques associated with capacity enhancement for a sidelink feedback channel, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, process 1800 of FIG. 18, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, process 1800 of FIG. 18, and/or other processes as described herein. In some examples, executing instructions may include running the instructions, converting the instructions, compiling the instructions, and/or interpreting the instructions, among other examples.

In some aspects, the UE 120 includes means for receiving a configuration of a feedback resource associated with a sidelink feedback channel, wherein the feedback resource is associated with an eight-level CDM scheme; and/or means for transmitting a feedback communication associated with a sidelink data communication using the feedback resource, wherein transmitting the feedback communication is based at least in part on using the eight-level CDM scheme to generate the feedback communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a configuration of a feedback resource associated with a sidelink feedback channel, wherein the feedback resource is associated with multiple sub-PRB interlaces; and/or means for transmitting a feedback communication associated with a sidelink data communication using the feedback resource, wherein transmitting the feedback communication is based at least in part on transmitting feedback information in a sub-PRB interlace, of the multiple sub-PRB interlaces. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a configuration of a feedback resource associated with a sidelink feedback channel, wherein the feedback resource is associated with multiple partial interlace groups; and/or means for transmitting a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

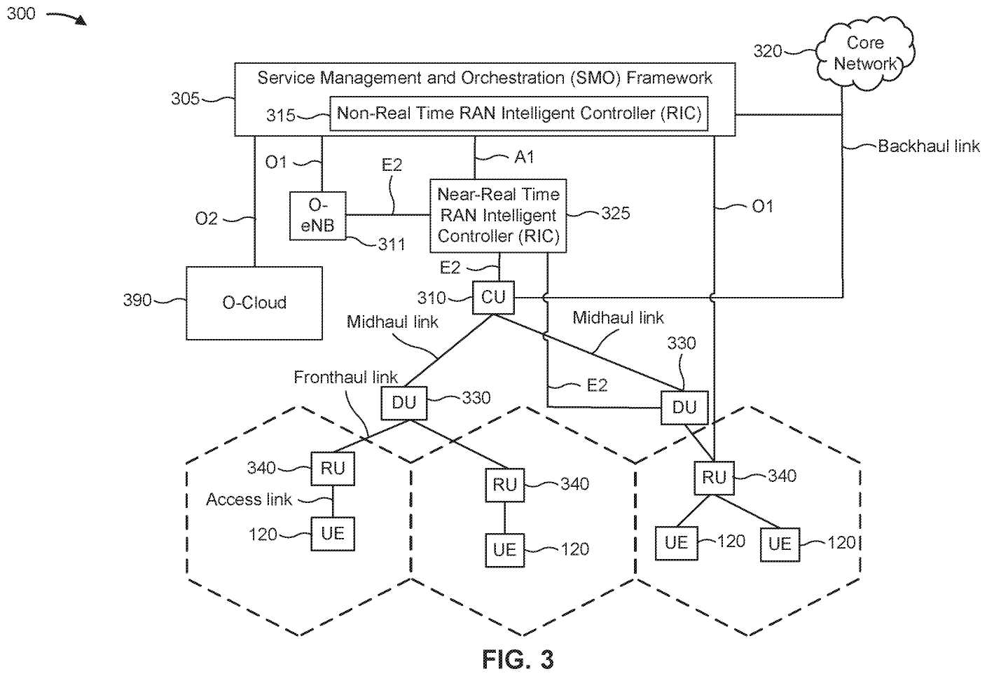

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

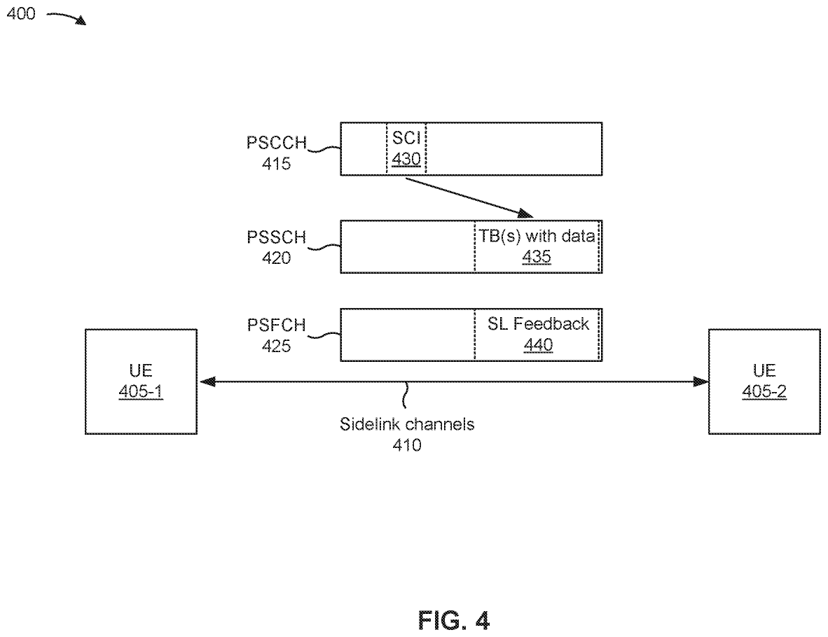

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

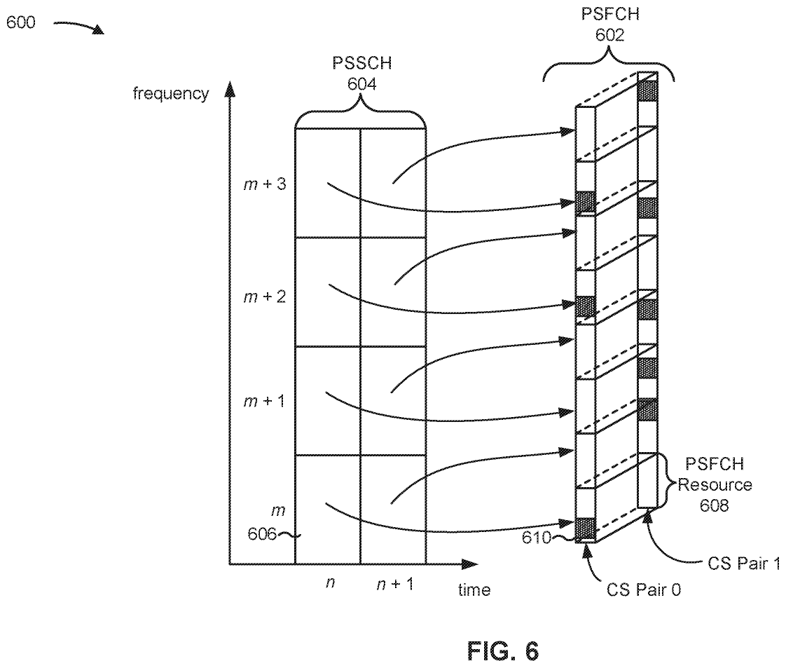

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR). Aspects of the PSFCH 425 are described in more detail below in connection with FIG. 6.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

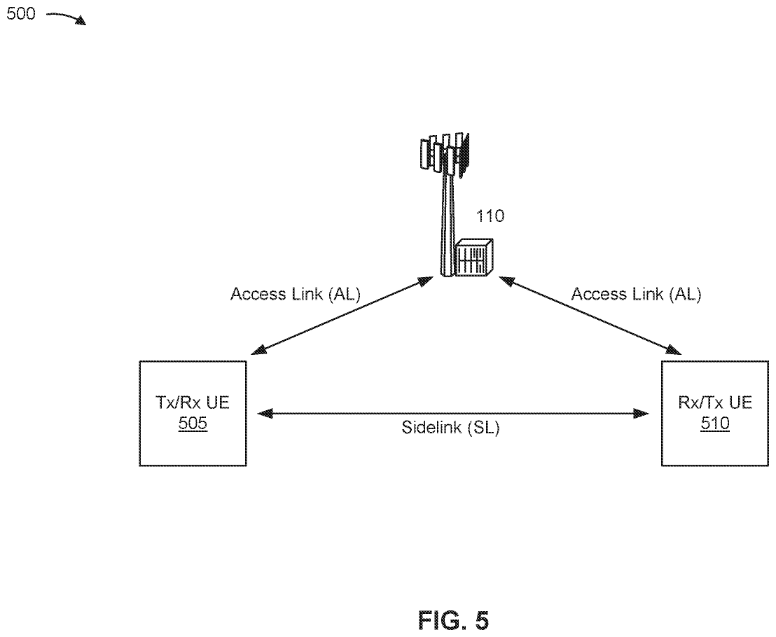

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1 and/or the UEs 405-1, 405-2 of FIG. 4. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

FIG. 6 is a diagram illustrating an example 600 of resources associated with a PSFCH 602, in accordance with the present disclosure. In some instances, the resources shown and described in connection with example 600 may be associated with sidelink communications, such as the communications described in connection with FIGS. 4 and 5. In that regard, the resources shown and described in connection with example 600 may be associated with communications between multiple UEs, UE 120, UE 405-1, UE 405-2, Tx/Rx UE 505, and/or Rx/TX UE 510. Additionally, or alternatively, the PSFCH 602 shown in FIG. 6 may correspond to the PSFCH 425 described in connection with FIG. 4.

In some aspects, the PSFCH 602 may be associated with (e.g., be used for providing feedback related to) a PSSCH 604, which may correspond to the PSSCH 420 described in connection with FIG. 4. In some aspects, the PSSCH 604 may be associated with a set of PSSCH occasion 606, which may be present across a resource grid associated with slots n and n+1 and subchannels m, m+1, m+2, and m+3. Each of the PSSCH occasions 606 may correspond to a different PSFCH resource 608 associated with the PSFCH 602. For example, for a received PSSCH communication in slot n and subchannel m, a UE 120 may transmit feedback information 610 over multiple PRBs within a corresponding PSFCH resource 608, as shown by the arrow connecting the PSSCH occasion 606 associated with slot n and subchannel m with the PSFCH resource 608 including the feedback information 610. Similarly, the other PSSCH occasions 606 may be associated with a corresponding PSFCH resource 608. In some cases, for each PSFCH resource 608, a UE 120 may use multiple length-l2 sequence repetitions across multiple PRBs and/or may use different cyclic shift (CS) pairs (e.g., CS pair 0 and CS pair 1) to differentiate between an ACK or a NACK for each sequence.

In some instances, resources associated with the PSFCH 602 may be associated with a resource pool, which may not be a dedicated PSFCH resource pool. Instead, the resource pool may be associated with resources for multiple sidelink communications, such as PSSCH communications, PSCCH communications, or the like, in addition to PSFCH communications. In such cases, a UE 120 providing feedback information may be configured with certain parameters to determine the PSFCH 602 and/or a specific PSFCH resource 608 for transmitting feedback information. For example, the UE 120 may receive an indication of a PSFCH period parameter (sometimes referred to as periodPSFCHresource), which may indicate a period (in a number of slots) within a resource pool for transmitting a PSFCH transmission. In some cases, the PSFCH period parameter (e.g., periodPSFCHresource) may be equal to 0 (meaning there is no PSFCH), 1 slot, 2 slots, or 4 slots. For a given PSSCH 604, the UE 120 may then transmit feedback information (e.g., ACK/NACK information) in a first slot associated with a PSFCH resource 608 after the PSSCH 604 and following a minimum time gap, which may be indicated by a PSFCH minimum time gap parameter (sometimes referred to as minTimeGapPSFCH).

Additionally, or alternatively, a UE 120 may receive an indication of a set of PRBs within a slot that are used for PSFCH transmission and reception, which is sometimes referred to as

$${M}_{PRB , set}^{PSFCH}$$

and/or sl-PSFCH-RB-Set. Each PSSCH occasion 606 may thus be associated with a number of PRBs, which may be a subset

$${M}_{PRB , set}^{PSFCH} .$$

More particularly, a PSSCH 604 may be associated with a number of slots associated with one PSFCH 602 slot (sometimes referred to as

$${N}_{PSSCH}^{PSFCH} ,$$

which, in the depicted example, is equal to 2 corresponding to slot n and slot n+1), and/or a PSSCH 604 may be associated with a number of subchannels within each slot (sometimes referred to as

$${N}_{subch}^{PSSCH} ,$$

which, in the depicted example, is equal to 4 corresponding to subchannels m, m+1, m+2, and m+3). In such cases, each subchannel/slot of the PSSCH 604 resource grid (e.g., each PSSCH occasion 606) may be associated with a number of PSFCH PRBs (sometimes referred to as

$${M}_{subch , slot}^{PSFCH} )$$

for PSFCH transmission and reception, which may be equal to

$$\frac{{M}_{PRB , set}^{PSFCH}}{{N}_{PSSCH}^{PSFCH} \times {N}_{subch}^{PSSCH}}$$

PRBs. Moreover, mapping between each subchannel/slot of the PSSCH 604 resource grid (e.g., each PSSCH occasion 606) and a corresponding PSFCH resource 608 may be performed in a time-first manner, as shown using arrows in FIG. 6. More particularly, a first-in-time PSSCH occasion 606 (e.g., a PSSCH occasion 606 in slot n) in a first subchannel (e.g., subchannel m) may be mapped to a first PSFCH resource 608, a second-in-time PSSCH occasion 606 in a first subchannel may be mapped to a second PSFCH resource 608, a first-in-time PSSCH occasion 606 in a second subchannel may be mapped to a third PSFCH resource 608, and so forth.

In some cases, a size of a PSFCH resource pool (sometimes referred to as

$${R}_{PRB , CS}^{PSFCH} ) ,$$

may be equal to

$${N}_{type}^{PSFCH} \times {N}_{CS}^{PSFCH} \times {M}_{subch , slot}^{PSFCH} .$$

In such cases,

$${N}_{type}^{PSFCH}$$

may be based at least in part on whether the PSFCH resource pool is associated with multiple subchannels in a PSSCH slot, and thus may be equal to either 1 (if the PSFCH resource pool is only associated with one PSSCH subchannel) or else the number of subchannels within each PSSCH slot (e.g.,

$${N}_{subch}^{PSSCH} ) ; {N}_{CS}^{PSFCH}$$

may correspond to a number of cyclic shift pairs associated with the PSFCH resource pool, which may be configured per resource pool; and M_{subch,slot}^{PSFCH} may correspond to the number of PSFCH PRBs associated with each subchannel/slot of the PSSCH 604 resource grid (e.g., each PSSCH occasion 606), as described above. Additionally, or alternatively, a UE 120 may determine a PSFCH resource according to the formula

$$( {P}_{ID} + {M}_{ID} ) mod {R}_{PRB , CS}^{PSFCH} , where {R}_{PRB , CS}^{PSFCH}$$

corresponds to the size of the PSFCH resource pool (as described above); P_{ID} corresponds to a physical source identifier indicated by an SCI (e.g., SCI-2A or SCI-2B) associated with the PSSCH 604; and M_{ID} is either 0 or corresponds to an identity of the UE 120 receiving the PSSCH 604. Put another way, for a unicast transmission, M_{ID} may be equal to 0 and the UE 120 will feedback in a PSFCH resource pool that is dependent only on a source identifier (e.g., P_{ID}), and for a groupcast transmission, each receiving UE 120 will pick a separate resource in the resource pool for transmitting feedback, which is dependent on both P_{ID} and M_{ID}.

As indicated above, FIG. 6 is provided as an example. Other examples may differ from what is described with respect to FIG. 6.

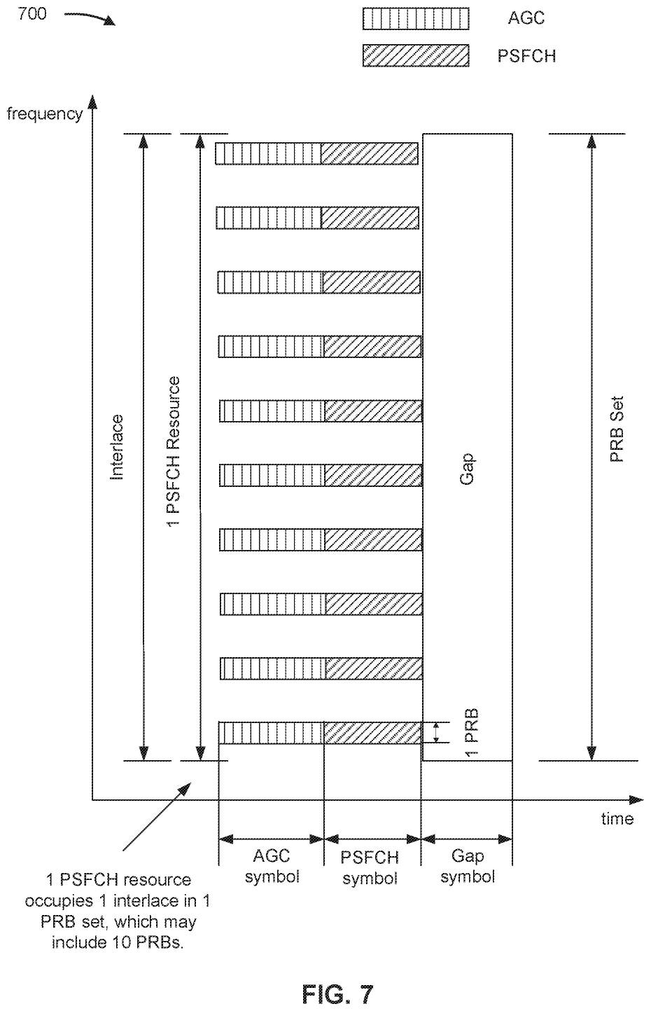

FIG. 7 is a diagram illustrating an example 700 of resources associated with an interlaced PSFCH waveform, in accordance with the present disclosure.

In some instances, a PSFCH resource pool (such as a PSFCH resource pool associated with the PSFCH 602 described in connection with FIG. 6), may be a single PRB and/or may not satisfy a temporary occupied channel bandwidth (OCB) requirement, which may be 2 MHz. Accordingly, in some cases, a PSFCH transmission may be interlaced across multiple PRBs in order to satisfy an OCB requirement, or otherwise. For example, as shown in FIG. 7, each PSFCH resource may occupy one interlace in one PRB set. As shown in FIG. 7, the interlaced PSFCH transmission uses non-consecutive PRBs to meet OCB requirements. In an example, the interlaced PSFCH may be separated by ten PRBs, resulting in an occupied bandwidth which may be much larger than a bandwidth associated with the PSFCH 602 described in connection with FIG. 6. In some cases, a PSFCH transmission associated with the interlaced waveform shown in FIG. 7 may include a length 12 sequence per PRB, and/or may include cyclic shift ramping. In some cases, a PSFCH symbol containing PSFCH resources may be preceded by an automatic gain control (AGC) symbol containing AGC resources, and/or each PSFCH PRB in the PSFCH symbol may be associated with (e.g., preceded by) an AGC PRB in the AGC symbol. Additionally, or alternatively, in some cases, a PSFCH symbol containing PSFCH resources may be followed by a gap symbol separating the PSFCH symbol and any subsequent data symbols, or the like.

As indicated above, FIG. 7 is provided as an example. Other examples may differ from what is described with respect to FIG. 7.

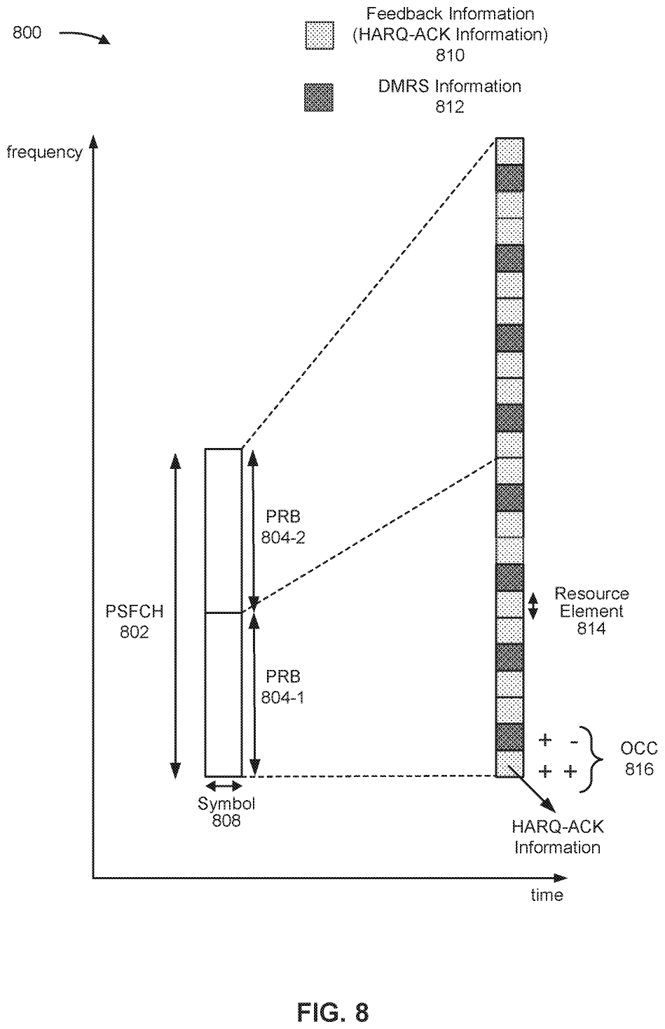

FIG. 8 is a diagram illustrating an example 800 of a PSFCH format 2 communication structure, in accordance with the present disclosure.

In some instances, the PSFCH format 2 communication structure shown in FIG. 8 may be implemented to carry multiple feedback (e.g., ACK/NACK) bits, such as when a HARQ codebook is associated with a PSFCH transmission. In such cases, to support relatively large payloads for a PSFCH 802 (which may correspond to the PSFCH 425 and/or the PSFCH 602), more than one PRB (e.g., X PRBs, such as PRB 804-1 and PRB 804-2) may be configured per resource pool in an PSFCH symbol 808. Moreover, feedback information 810 (e.g., HARQ-ACK information) and DMRS information 812 may be frequency division multiplexed in the PSFCH symbol 808. In some cases, a UE 120 may allocate the feedback information 810 to various resource elements 814 (shown as “RE 814” in FIG. 8) and/or the UE 120 may allocate the DMRS information 812 to other resource elements 814 in accordance with a multiplexing pattern associated with the PSFCH format 2 communication structure.

Prior to or after multiplexing the feedback information 810 with the DMRS information 812, the UE 120 may apply a coding scheme to the feedback information 810 (such as to multiple feedback bits). In some cases, a UE 120 may apply a Reed-Muller coding scheme to the feedback information 810, which may reduce the cyclic redundancy check (CRC) overhead associated with the feedback information 810. In some other cases, either a Reed-Muller coding scheme or a polar coding scheme may be used based at least in part on a quantity of bits included in, or otherwise conveyed by, the feedback information 810. Put another way, whether Reed-Muller coding or polar coding is implemented may depend on whether the feedback information is associated with a threshold number of bits. For example, the UE 120 may apply a Reed-Muller code to the feedback information 810 to reduce a CRC overhead if a size or quantity of feedback information bits is less than or equal to a threshold quantity of bits (such as 11 bits), and the UE 120 may include one or more CRC bits and apply a polar code to the feedback information 810 if the size or quantity of the feedback information bits is greater than the threshold quantity of bits.

In some instances, the UE 120 may apply a frequency domain orthogonal cover code (FD-OCC) scheme on the PSFCH format 2 communication structure in order to increase PSFCH multiplexing capacity. For example, as shown by reference number 816, the UE 120 may apply two-level FD-OCC or four-level OCC to the feedback information 810 and the DMRS information 812. In such cases, data modulation symbols are repeated two times (e.g., for two-level FD-OCC) or four times (e.g., for four-level FD-OCC) in the frequency domain, and two-level or four-level FD-OCC is applied to the data modulation symbols. In such cases, the two-level or four-level FD-OCC may also be directly applied on a legacy DMRS sequence. By implementing two-level FD-OCC or four-level FD-OCC in this manner, a PSFCH multiplexing capacity is increased by two times or four times, respectively. In such instances, if a receiving UE 120 (e.g., a UE 120 receiving a PSSCH communication) supports multiple PSFCH format 2 transmissions, the UE 120 may be able to transmit up to two or four (corresponding to two-level or four-level FD-OCC) PSFCH communications per interlace described in connection with FIG. 7.

As indicated above, FIG. 8 is provided as an example. Other examples may differ from what is described with respect to FIG. 8.

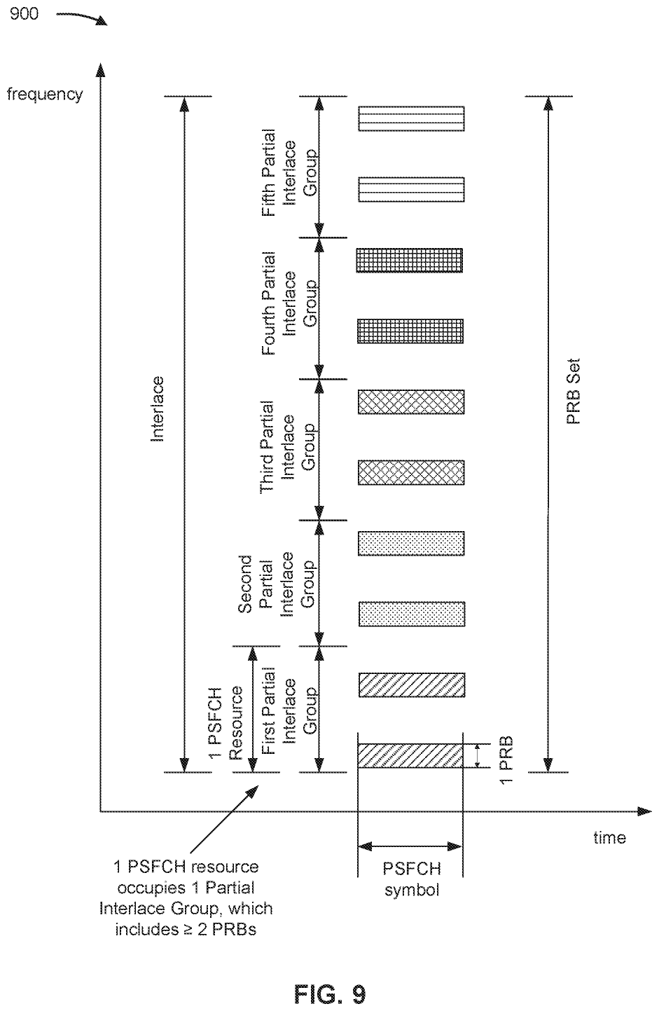

FIG. 9 is a diagram illustrating an example 900 of a partial interlace waveform associated with a PSFCH, in accordance with the present disclosure. As shown in FIG. 9, each PSFCH resource may occupy one partial interlace group of an interlace (such as the interlace described in connection with FIG. 7) in the frequency domain, where each partial interlace group includes at least two interlaced PRBs in the frequency domain. For example, the interlace may include ten interlaced PRBs in the frequency domain, where the PRBs are non-consecutive (as described above in connection with FIG. 7). The ten interlaced PRBs may be partitioned into multiple partial interlace groups, where each partial interlace group consists of an amount, X, of PRBs. X PRBs per partial interlace group may be equal to or greater than two to fulfill the temporary 2 MHz OCB requirement in the sidelink unlicensed band (e.g., 2 PRBs=2.16 MHz). Although the example illustrated in FIG. 9 shows each partial interlace group as having 2 PRBs (e.g., X=2), in some other cases, each partial interlace group may have a different amount, X, of RBs (e.g., each partial interlace group may have five PRBs, where X=5). Each interlace (e.g., each of the interlaces described in connection with FIG. 7) may thus include N/X partial interlace groups, where N is equal to a total number of PRBs associated with an interlace. For example, for partial interlaces associated with two PRBs (e.g., X=2), an interlace associated with ten PRBs includes 10/2=5 partial interlace groups, as shown in FIG. 9.

One PSFCH resource may map to a partial interlace group containing X PRBs, and different PSFCH resources with the same cyclic shift and interlace index may map to non-overlapping PRBs within the interlace. In some cases, the X PRBs of the partial interlace may be contiguous PRBs within the interlace (e.g., a first partial interlace group is associated with the first X PRBs in the interlace, the second partial interlace group is associated with next X PRBs in the interlace, and so forth, as shown in FIG. 9), while, in some other cases, the X PRBs of the partial interlace may be non-contiguous PRBs within the interlace. In some instances, cyclic shift ramping may be applied across the X PRBs of a partial interlace group, such as for purposes of reducing a peak-to-average power ratio (PAPR).

As indicated above, FIG. 9 is provided as an example. Other examples may differ from what is described with respect to FIG. 9.

One or more of the above-described PSFCH communication structures may be used by UEs 120 to improve UE 120 multiplexing capacity and thus increase throughput of PSFCH communications. For example, as described in connection with FIG. 8, using two-level FD-OCC or four-level FD-OCC-2/4 on PSFCH format 2 communications, which include feedback information 810 and DMRS information 812, may improve UE 120 multiplexing capacity when a PSFCH communication occupies one symbol. However, even with the use of FD-OCC, the UE 120 multiplexing capacity may still be less than a legacy PSFCH communication for a given bandwidth, because the interlaced waveform requires ten RBs as compared to K RBs required for a legacy PSFCH communication (with K being much smaller than 10). Moreover, using the partial interlace waveform described in connection with FIG. 9 may increase resource capacity while still satisfying a temporary OCB constraint of 2 MHz, but a number of PSFCH resources associated with the partial interlace waveform may still be less than a legacy PSFCH communication. For example, for a 50 PRB bandwidth, using the partial interlace waveform may result in up to 150 PSFCH resources (e.g., six cyclic shift pairs×five interlaces×5 partial interlace groups=150 PSFCH resources), which is two times less than the number of PSFCH resources using a legacy PSFCH communication (e.g., 300 PSFCH resources). As a result, using the above-described PSFCH communication structures in order to satisfy OCB requirements or the like may correspondingly result in reduced sidelink feedback capacity, leading to increased latency associated with sidelink communications and thus reduced throughput and overall inefficient usage of network resources.

Some techniques and apparatuses described herein enable increased PSFCH resources using one or more of the PSFCH communication structures described above. In some aspects, a capacity of PSFCH communications in one interlace (such as the interlace described in connection with FIG. 7) may be increased by using an eight-level CDM scheme. In some aspects, the eight-level CDM scheme may be associated with a two-level TD-OCC scheme and a four-level FD-OCC scheme. In some other aspects, the eight-level CDM scheme may be associated with a four-level TD-OCC scheme and a two-level FD-OCC scheme. And in some other aspects, the eight-level CDM scheme may be associated with a first step FD-OCC scheme and a second-step FD-OCC scheme. Additionally, or alternatively, a capacity of PSFCH communications in one interlace (such as the interlace described in connection with FIG. 7) may be increased by using sub-PRB interlacing, in which multiple PSFCH communications may be multiplexed within on PRB. Additionally, or alternatively, a capacity of PSFCH communications in a partial interlace group (such as one of the partial interlace groups described in connection with FIG. 9) may be increased by applying a TD-OCC scheme to feedback communications within the partial interlace group. As a result, techniques and apparatuses described herein result in increased sidelink feedback capacity, decreased latency associated with sidelink communications, increased throughput associated with sidelink communications, and overall more efficient usage of network resources. This may be more readily understood with reference to FIGS. 10-15, described below.

FIG. 10 is a diagram of an example 1000 associated with a feedback resource associated with an eight-level CDM scheme, in accordance with the present disclosure. As shown in FIG. 10, a network node 110 may communicate with a first UE 120-1 (e.g., UE 120), and/or the first UE 120-1 may communicate with a second UE 120-2 (e.g., UE 120). For example, the network node 110 may communicate with the first UE 120-1 via an access link, such as one of the access links described in connection with FIG. 5, and the first UE 120-1 may communicate with the second UE 120-2 via a sidelink, such as the sidelink described in connection with FIG. 5. In some aspects, the network node 110, the first UE 120-1, and the second UE 120-2 may be part of a wireless network (e.g., wireless network 100). The network node 110, the first UE 120-1, and the second UE 120-2 may have established a wireless connection prior to operations shown in FIG. 10. For example, the network node 110 and the first UE 120-1 may have established a wireless connection via a Uu interface, and the first UE 120-1 and the second UE 120-2 may have established a wireless connection via a PC5 interface.

As shown by reference number 1005, the network node 110 may transmit, and the first UE 120-1 may receive, configuration information. In some aspects, the first UE 120-1 may receive the configuration information via one or more of RRC signaling, one or more MAC control elements (MAC-CEs), and/or DCI, among other examples. In some aspects, the configuration information may include an indication of one or more configuration parameters (e.g., already known to the first UE 120-1 and/or previously indicated by the network node 110 or other network device) for selection by the first UE 120-1, and/or explicit configuration information for the first UE 120-1 to use to configure the first UE 120-1, among other examples. In some aspects, the network node 110 may transmit the configuration information to one or more additional UEs 120. For example, in some aspects, the network node 110 may also transmit the configuration information to the second UE 120-2.

In some aspects, the configuration information may include a configuration of a feedback resource (e.g., a PSFCH resource) associated with a sidelink feedback channel (e.g., a PSFCH), wherein the feedback resource is associated with an eight-level CDM scheme. Moreover, in some aspects, the feedback communication may be associated with one or more feedback communication structures described above in connection with FIGS. 6-9. For example, in some aspects, the feedback communication may be associated with a PSFCH format 2 communication.

Moreover, because the feedback resource is associated with an eight-level CDM scheme, in some aspects, the feedback resource may be associated with multiple symbols within a slot. That is, the feedback resource may span multiple contiguous symbols within a slot. For example, the feedback resource may be associated with M contiguous symbols located prior to a last gap symbol within a slot, such as the gap symbol shown and described in connection with FIG. 7. In some aspects, a quantity of the multiple contiguous symbols (e.g., M) may be preconfigured, and in some other aspects, the quantity of contiguous symbols may be indicated via a RRC communication, such as the communication shown and described in connection with reference number 1005.

Moreover, in some aspects, the quantity of contiguous symbols may be associated with a resource pool associated with the feedback communication (e.g., the quantity of PSFCH symbols within a slot may be RRC configured at the resource pool level). Additionally, or alternatively, in some aspects, the configuration information may include a configuration of a resource pool associated with the feedback communication. Moreover, in some aspects, a size of the resource pool may be based at least in part on the eight-level CDM scheme. For example, because a feedback communication may be repeated eight times to accommodate the eight-level CDM scheme, including multiple times in the frequency domain and/or multiple times in the time domain, the network node 110 may configure a relatively large resource pool to accommodate for the eight-level CDM scheme.

The first UE 120-1 may configure itself based at least in part on the configuration information. In some aspects, the first UE 120-1 may be configured to perform one or more operations described herein based at least in part on the configuration information.

As shown by reference number 1010, the second UE 120-2 may transmit, and the first UE 120-1 may receive, a sidelink data communication. For example, the UE 120-2 may transmit a communication associated with a PSSCH, as described in connection with FIGS. 4-6. Moreover, in some aspects, the first UE 120-1 may be configured to provide a feedback communication associated with the sidelink data communication, such as an HARQ-ACK communication associated with the sidelink data communication. Accordingly, and as shown by reference number 1015, the first UE 120-1 may use an eight-level CDM scheme to generate a feedback communication associated with the sidelink data communication.

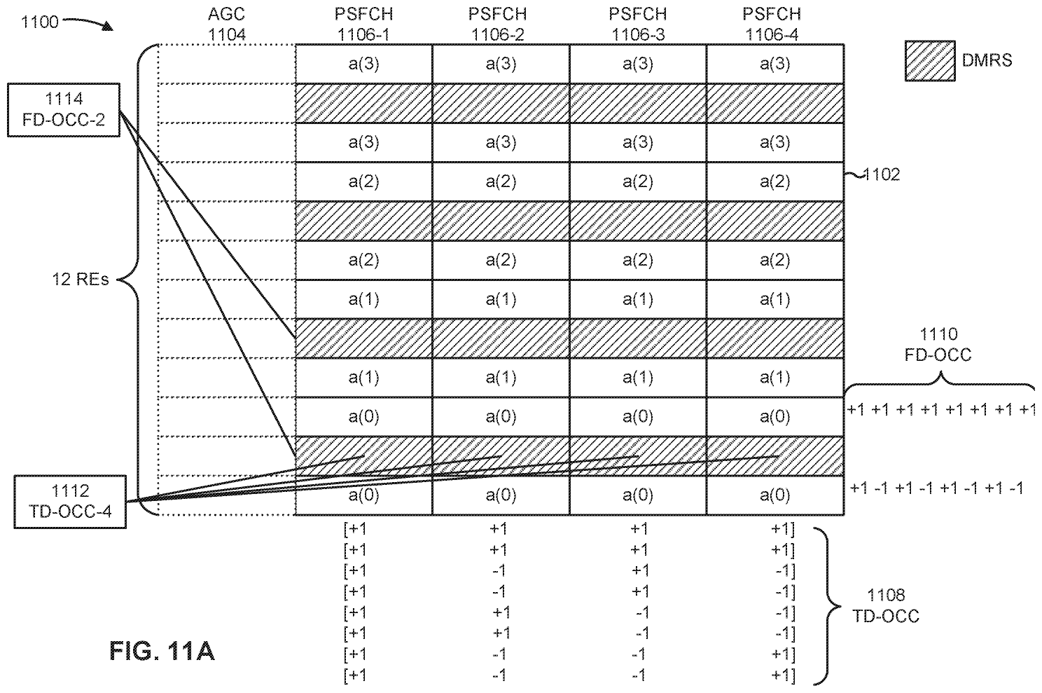

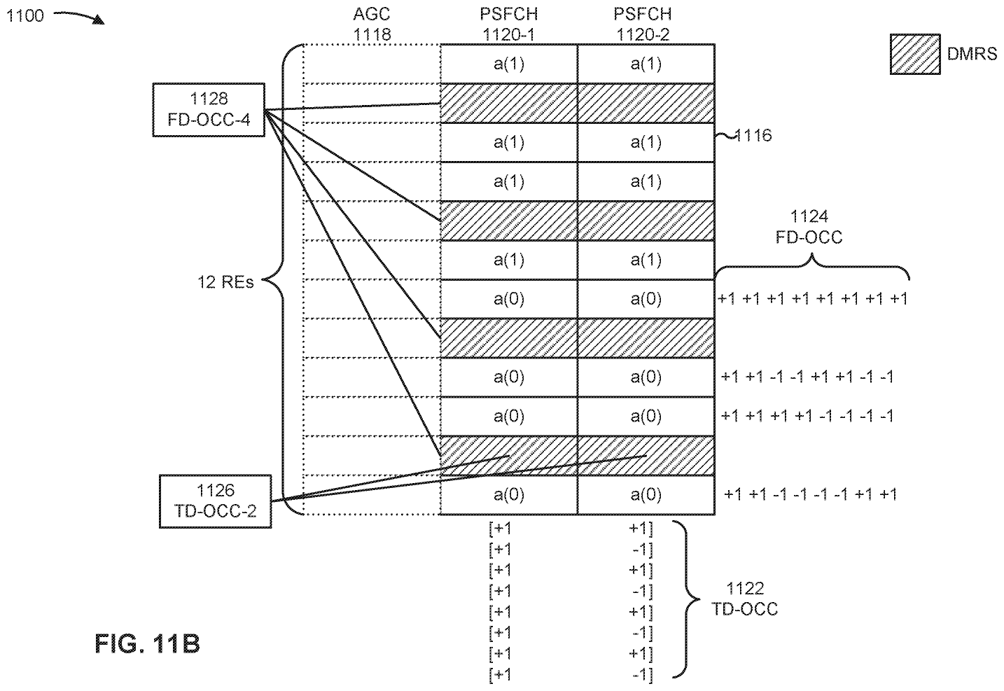

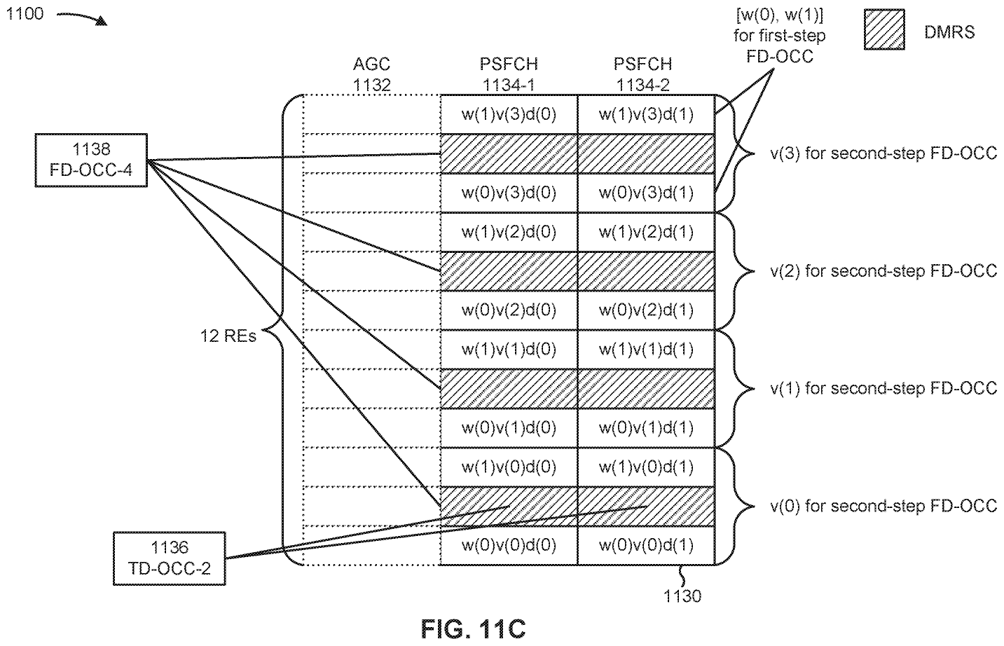

In some aspects, the eight-level CDM scheme may be associated with a TD-OCC scheme and a FD-OCC scheme. For example, the eight-level CDM scheme may be associated with a four-level TD-OCC scheme and a two-level FD-OCC scheme, which is described in more detail in connection with FIG. 11A. Alternatively, the eight-level CDM scheme may be associated with a two-level TD-OCC scheme and a four-level FD-OCC scheme, which is described in more detail in connection with FIG. 11B. In some other aspects, the eight-level CDM scheme may associated with a first-step FD-OCC scheme and a second-step FD-OCC scheme, which is described in more detail in connection with FIG. 11C.

As shown by reference number 1020, the first UE 120-1 may transmit, and the second UE 120-2 may receive, a feedback communication associated with the sidelink data communication. In some aspects, the first UE 120-1 may transmit the feedback communication associated with a sidelink data communication using a feedback resource configured by the configuration information described above in connection with reference number 1005. For example, the feedback resource may be associated with a PSFCH 1025, and thus the first UE 120-1 may transmit the feedback communication in the PSFCH 1025, as shown in FIG. 10. In some aspects, transmitting the feedback communication may be based at least in part on using the eight-level CDM scheme to generate the feedback communication, as described in connection with reference number 1015.

Additionally, or alternatively, in some aspects, the first UE 120-1 may transmit the feedback communication using an interlaced waveform, such as by using the interlace waveform described above in connection with FIG. 7. In some aspects, the first UE 120-1 may transmit the feedback communication using a scheduled interlace associated with the feedback resource. In such aspects, the scheduled interlace may be associated with multiple non-contiguous PRBs, as described.

Moreover, in order to control a cubic metric (CM) and/or a PAPR associated with the feedback communication when OCCs are configured (such as one or more TD-OCC schemes and/or one or more FD-OCC schemes), or to provide similar benefits, the first UE-120-1 may perform FD-OCC cycling across the non-contiguous PRBs of the scheduled interlace. More particularly, in some aspects, the eight-level CDM scheme may be associated with a FD-OCC scheme, and the feedback communication may be transmitted using FD-OCC cycling such that an FD-OCC sequence changes between subsequent PRBs, of the multiple non-contiguous PRBs, associated with the scheduled interlace. In such aspects, an FD-OCC sequence index associated with a corresponding FD-OCC sequence in a corresponding PRB, of the multiple non-contiguous PRBs, may be determined by the first UE 120-1 based at least in part on an FD-OCC-cycling formula. For example, an FD-OCC sequence index associated with an i-th PRB in an interlace (sometimes referred to as nᵢ) may be based at least in part on the FD-OCC-cycling formula

$${n}_{i} = ( {n}_{0} + i ) mod {N}_{OCC}^{PSFCH} ,$$

where n₀ may correspond to an initial FD-OCC sequence index, and where

$${N}_{OCC}^{PSFCH}$$

may correspond to a length of the corresponding FD-OCC sequence.

In some aspects, such as for aspects in which the first UE 120-1 is within network coverage (e.g., when the first UE 120-1 is in an RRC connected state with the network node 110), the initial FD-OCC sequence index may be indicated via a RRC communication (e.g., via the configuration information described in connection with reference number 1005 or else via a different RRC communication). In some other aspects, the initial FD-OCC sequence index may be based at least in part on a source identifier associated with the feedback resource, such as the physical source identifier (e.g., P_{ID}) described in connection with FIG. 6, which may be indicated via an SCI-2A or SCI-2B communication transmitted by the second UE 120-2. Additionally, or alternatively, the initial FD-OCC sequence index may be based at least in part on a zone identifier associated with the feedback resource, which, in some aspects, may be indicated in an SCI communication transmitted by the second UE 120-2, such as an SCI-2B communication. Additionally, or alternatively, the initial FD-OCC sequence index may be dynamically indicated to the first UE 120-1, such as via an SCI communication transmitted by the second UE 120-2. Additional aspects of a feedback resource is associated with an eight-level CDM scheme are described in more detail below in connection with FIGS. 11A-11C.

As indicated above, FIG. 10 is provided as an example. Other examples may differ from what is described with respect to FIG. 10.

FIGS. 11A-11C are diagrams illustrating an example 1100 associated with a feedback resource associated with an eight-level CDM scheme, in accordance with the present disclosure.

First, FIG. 11A shows an example in which the eight-level CDM scheme, described above in connection with FIG. 10, is associated with a four-level TD-OCC scheme and a two-level FD-OCC scheme. In this example, because the eight-level CDM scheme is associated with the four-level TD-OCC scheme, PSFCH data symbols may be repeated four times in the time domain. Similarly, because the eight-level CDM scheme is further associated with the two-level FD-OCC scheme, feedback information is repeated two times in the frequency domain. As a result of the four-level TD-OCC scheme and the two-level FD-OCC scheme, PSFCH multiplexing capacity may be increased by eight times.

More particularly, the feedback resource example shown in FIG. 11A includes a resource grid 1102 including five symbols in the time domain, and 12 REs in the frequency domain (e.g., one PRB in the frequency domain). The five symbols in the time domain include an AGC symbol 1104, and four PSFCH symbols 1106, shown as 1106-1, 1106-2, 1106-3, and 1106-4. The feedback resource may be capable of frequency division multiplexing feedback information, shown as the unshaded REs in FIG. 11A, with DMRS information, shown using cross-hatching in FIG. 11A. Put another way, a feedback communication that is transmitted using the structure shown in FIG. 11A includes DMRS information that is frequency division multiplexed with feedback information.

Moreover, the feedback resource example shown in FIG. 11A may include multiple sets of feedback information or PSFCH data symbols, shown as a(n) in FIG. 11A. As shown, each set of PSFCH data symbols (e.g., a(n)) may be repeated four times in the time domain, and two times in the frequency domain. Moreover, as indicated by reference number 1108, a four-level TD-OCC scheme may be applied to the set of PSFCH data symbols, and, as indicated by reference number 1110, a two-level FD-OCC scheme may be applied to set of PSFCH data symbols, resulting in an eight-level CDM scheme being applied to each set of PSFCH data symbols (e.g., resulting in an increase in PSFCH multiplexing capacity by eight times). In this regard, four sets of the PSFCH data symbols (e.g., a(0), a(1), a(2), and a(3)), may be transmitted in the resource grid 1102, as shown.

Moreover, a feedback communication transmitted using the depicted structure may include DMRS information (e.g., the cross-hatched REs) that is frequency division multiplexed with feedback information (e.g., the unshaded REs), as described. In some aspects, the TD-OCC scheme and the FD-OCC scheme that are applied to the feedback information (e.g., the TD-OCC scheme and the FD-OCC scheme that are applied to each set of PSFCH data symbols, a(n)) are also applied to the DMRS information. More particularly, as shown by reference number 1112, the four-level TD-OCC scheme may be applied to the DMRS information (e.g., a legacy DMRS sequence), and, as shown by reference number 1114, the two-level FD-OCC scheme may also be applied to the DMRS information. Applying the eight-level CDM scheme (which, in this aspect, includes the four-level TD-OCC scheme and the two-level FD-OCC scheme) to the DMRS information may beneficially orthogonalize the DMRS sequences transmitted by one or more UEs 120.

FIG. 11B shows an example in which the eight-level CDM scheme, described above in connection with FIG. 10, is associated with a two-level TD-OCC scheme and a four-level FD-OCC scheme. In this example, because the eight-level CDM scheme is associated with the two-level TD-OCC scheme, PSFCH data symbols may be repeated two times in the time domain. Similarly, because the eight-level CDM scheme is further associated with the four-level FD-OCC scheme, feedback information is repeated four times in the frequency domain. As a result of the two-level TD-OCC scheme and the four-level FD-OCC scheme, PSFCH multiplexing capacity may be increased by eight times.

More particularly, the feedback resource example shown in FIG. 11B includes a resource grid 1116 including three symbols in the time domain, and 12 REs in the frequency domain (e.g., one PRB in the frequency domain). The three symbols in the time domain include an AGC symbol 1118 and two PSFCH symbols 1120, shown as 1120-1 and 1120-2. The feedback resource may be capable of frequency division multiplexing feedback information, shown as the unshaded REs in FIG. 11B, with DMRS information, shown using cross-hatching in FIG. 11B. Put another way, a feedback communication that is transmitted using the structure shown in FIG. 11B includes DMRS information that is frequency division multiplexed with feedback information.

Moreover, the feedback resource example shown in FIG. 11B may include multiple sets of feedback information or PSFCH data symbols, shown as a(n) in FIG. 11B. As shown, each set of PSFCH data symbols (e.g., a(n)) may be repeated two times in the time domain and four times in the frequency domain. Moreover, as indicated by reference number 1122, a two-level TD-OCC scheme may be applied to the set of PSFCH data symbols, and, as indicated by reference number 1124, a four-level FD-OCC scheme may be applied to the set of PSFCH data symbols, resulting in an eight-level CDM scheme being applied to each set of PSFCH data symbols (e.g., resulting in an increase in PSFCH multiplexing capacity by eight times). In this regard, two sets of the PSFCH data symbols (e.g., a(0) and a(1)), may be transmitted in the resource grid 1116, as shown.

Moreover, a feedback communication transmitted using the depicted structure may include DMRS information (e.g., the cross-hatched REs) that is frequency division multiplexed with feedback information (e.g., the unshaded REs), as described. In some aspects, the TD-OCC scheme and the FD-OCC scheme that are applied to the feedback information (e.g., the TD-OCC scheme and the FD-OCC scheme that are applied to each set of PSFCH data symbols, a(n)) are also applied to the DMRS information. More particularly, as shown by reference number 1126, the two-level TD-OCC scheme may be applied to the DMRS information (e.g., a legacy DMRS sequence), and, as shown by reference number 1128, the four-level FD-OCC scheme may be applied to the DMRS information. Applying the eight-level CDM scheme (which, in this aspect, includes the two-level TD-OCC scheme and the four-level FD-OCC scheme) to the DMRS information may beneficially orthogonalize the DMRS sequences transmitted by one or more UEs 120.

FIG. 11C shows an example in which the eight-level CDM scheme, described above in connection with FIG. 10, is associated with a first-step FD-OCC scheme and a second-step FD-OCC scheme. In some aspects, as shown in FIG. 11C, the first-step FD-OCC scheme may be associated with a two-level FD-OCC scheme, and the second-step FD-OCC scheme may be associated with a four-level FD-OCC scheme. In this example, because the eight-level CDM scheme is associated with the two-level FD-OCC scheme and the four-level FD-OCC scheme, sets of feedback information or PSFCH data symbols, shown as d(n) in FIG. 11C, may be repeated eight times in the frequency domain. As a result of the first-step FD-OCC scheme (e.g., two-level FD-OCC) and a second-step FD-OCC scheme (e.g., four-level FD-OCC), PSFCH multiplexing capacity may be increased by eight times.

More particularly, the feedback resource example shown in FIG. 11B includes a resource grid 1130 including three symbols in the time domain, and 12 REs in the frequency domain (e.g., one RB in the frequency domain). The three symbols in the time domain include an AGC symbol 1132 and two PSFCH symbols 1134, shown as 1134-1 and 1134-2. The feedback resource may be capable of frequency division multiplexing feedback information, shown as the unshaded REs in FIG. 11C, with DMRS information, shown using cross-hatching in FIG. 11C. Put another way, a feedback communication that is transmitted using the structure shown in FIG. 11C includes DMRS information that is frequency division multiplexed with feedback information.

Moreover, the feedback resource example shown in FIG. 11C may include multiple sets of feedback information or PSFCH data symbols, shown as d(n) in FIG. 11B. As shown, each set of PSFCH data symbols (e.g., d(n)) may be repeated eight times in the frequency domain. Moreover, as indicated by w(n), a first-step FD-OCC scheme (e.g., a two-level FD-OCC scheme) may be applied to the sets of PSFCH data symbols, and, as indicated by sequence v(n), a second-step FD-OCC scheme (e.g., a four-level FD-OCC scheme) may be applied to the sets of PSFCH data symbols, resulting in an eight-level CDM scheme being applied to each set of PSFCH data symbols (e.g., resulting in an increase in PSFCH multiplexing capacity by eight times).

More particularly, each PSFCH symbol 1134 may carry one unique set of PSFCH data symbols, shown as d(0) in PSFCH symbol 1134-1 and shown as d(1) in PSFCH symbol 1134-2. Each set of PSFCH data symbols (e.g., d(n)) may then be block-wise spread using an orthogonal sequence. The block-wise spread bits may be mapped to REs that exclude DMRS information. Put another way, the block-wise spread bits may be mapped to the unshaded REs shown in FIG. 11C. The first-step (e.g., two-level) FD-OCC scheme is shown as w(n) in FIG. 11C, and may include two OCC sequences (e.g., [w(0), w(1)]), such as [+1 +1] and [+1 −1]. The second-step (e.g., four-level) FD-OCC scheme is shown as v(n) in FIG. 11C, and may include four OCC sequences (e.g., [v(0), v(1), v(2), v(3)]), such as [+1 +1 +1 +1], [+1 −1 +1 −1], [+1 +1 −1 −1], and [+1 −1 −1 +1].

Moreover, a feedback communication transmitted using the depicted structure may include DMRS information (e.g., the cross-hatched REs) that is frequency division multiplexed with feedback information (e.g., the unshaded REs), as described. In some aspects, the DMRS information may be associated with a different CDM scheme than the feedback information. For example, although the feedback information may be associated with a first-step FD-OCC scheme and a second-step FD-OCC scheme, as described, a TD-OCC scheme and another FD-OCC scheme may be applied to the DMRS information. More particularly, as shown by reference number 1136, a two-level TD-OCC scheme may be applied to the DMRS information (e.g., a legacy DMRS sequence), and, as shown by reference number 1138, a four-level FD-OCC scheme may be applied to the DMRS information. Applying the eight-level CDM scheme (which, in this aspect, includes the two-level TD-OCC scheme and the four-level FD-OCC scheme) to the DMRS information may beneficially orthogonalize the DMRS sequences transmitted by one or more UEs 120.

As indicated above, FIGS. 11A-11C are provided as an example. Other examples may differ from what is described with respect to FIGS. 11A-11C.

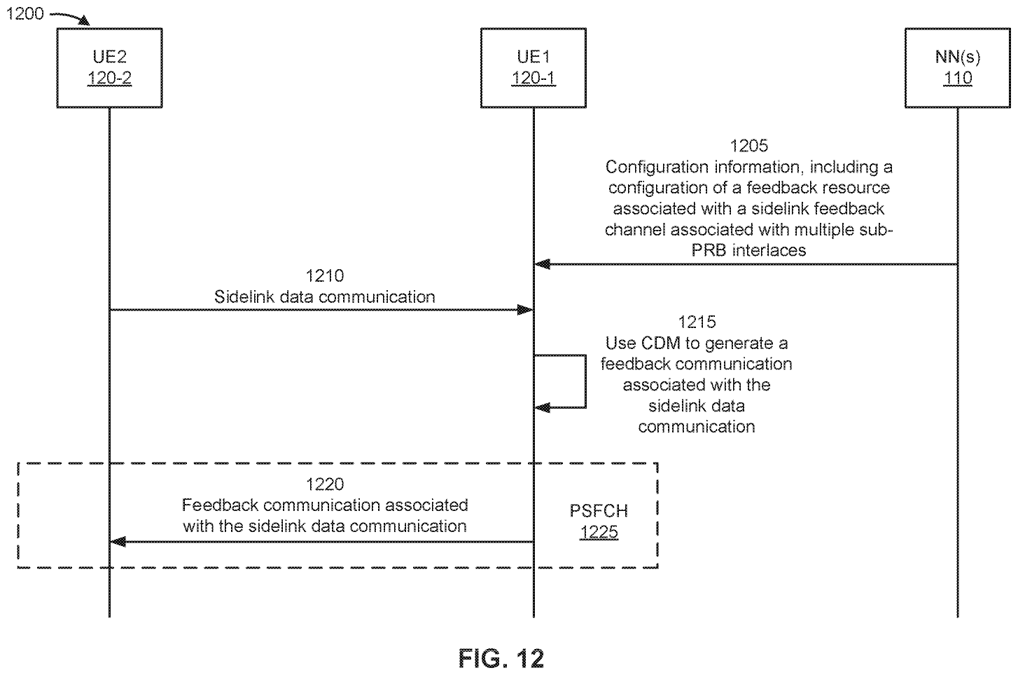

FIG. 12 is a diagram of an example 1200 associated with a feedback resource associated with a sub-PRB interlace, in accordance with the present disclosure. As shown in FIG. 12, a network node 110 may communicate with a first UE 120-1 (e.g., UE 120), and/or the first UE 120-1 may communicate with a second UE 120-2 (e.g., UE 120). For example, the network node 110 may communicate with the first UE 120-1 via an access link, such as one of the access links described in connection with FIG. 5, and the first UE 120-1 may communicate with the second UE 120-2 via a sidelink, such as the sidelink described in connection with FIG. 5. In some aspects, the network node 110, the first UE 120-1, and the second UE 120-2 may be part of a wireless network (e.g., wireless network 100). The network node 110, the first UE 120-1, and the second UE 120-2 may have established a wireless connection prior to operations shown in FIG. 10. For example, the network node 110 and the first UE 120-1 may have established a wireless connection via a Uu interface, and the first UE 120-1 and the second UE 120-2 may have established a wireless connection via a PC5 interface.

As shown by reference number 1205, the network node 110 may transmit, and the first UE 120-1 may receive, configuration information. In some aspects, the first UE 120-1 may receive the configuration information via one or more of RRC signaling, one or more MAC-CEs, and/or DCI, among other examples. In some aspects, the configuration information may include an indication of one or more configuration parameters (e.g., already known to the first UE 120-1 and/or previously indicated by the network node 110 or other network device) for selection by the first UE 120-1, and/or explicit configuration information for the first UE 120-1 to use to configure the first UE 120-1, among other examples. In some aspects, the network node 110 may transmit the configuration information to one or more additional UEs 120. For example, in some aspects, the network node 110 may also transmit the configuration information to the second UE 120-2.

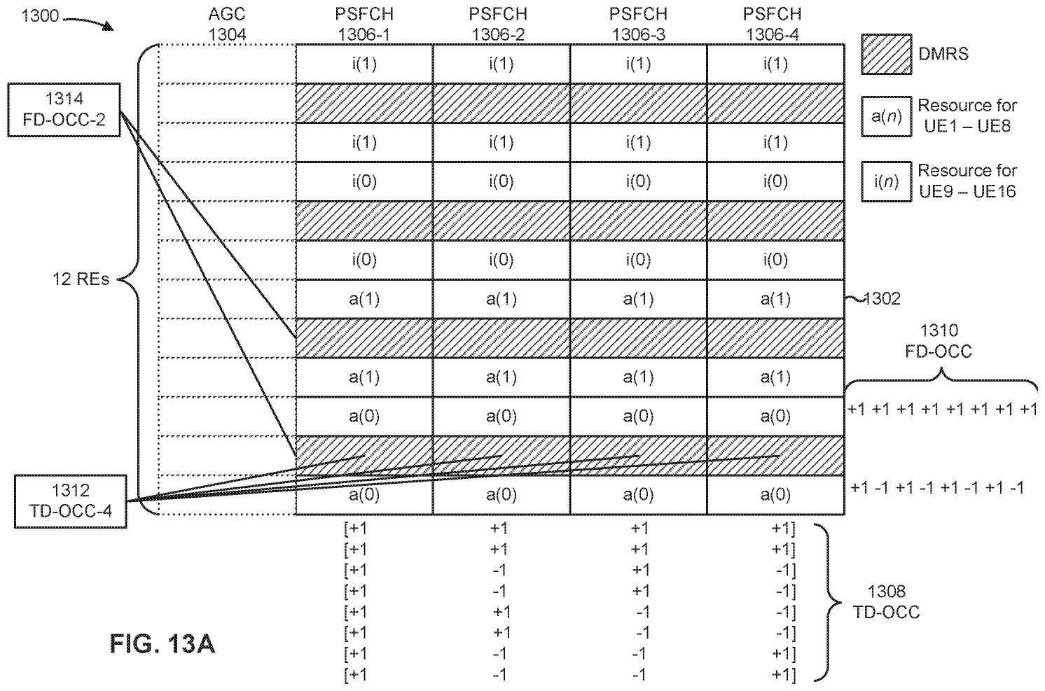

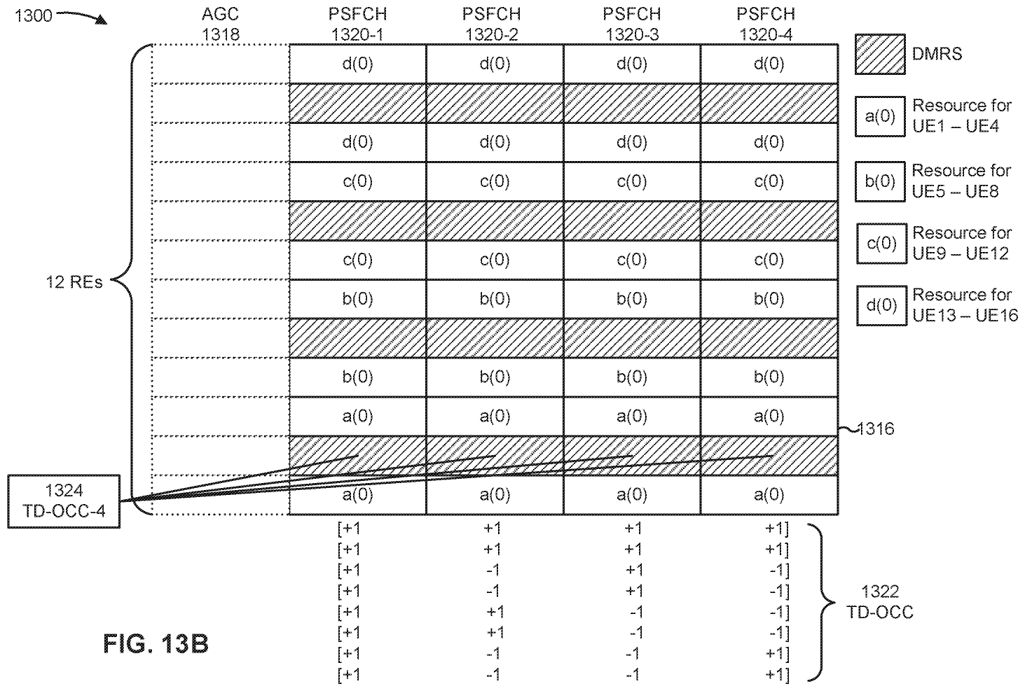

In some aspects, the configuration information may include a configuration of a feedback resource (e.g., a PSFCH resource) associated with a sidelink feedback channel (e.g., a PSFCH), wherein the feedback resource is associated with multiple sub-PRB interlaces. As is described in more detail in connection with FIGS. 13A-13B, a sub-PRB interlace may include allocating a set of one or more REs within a PRB to a UE 120 or a set of UEs, such that multiple UEs or multiple sets of UEs may transmit feedback information within a PRB. For example, a first UE 120 or a first set of UEs 120 may be associated with a first RE within a PRB, a second UE 120 or a second set of UEs 120 may be associated with a second RE within the PRB, and so forth. As another example, a first UE 120 or a first set of UEs 120 may be associated with a first set of X contiguous REs within a PRB, a second UE 120 or a second set of UEs 120 may be associated with a second set of X contiguous REs within the PRB, and so forth.

In some aspects, the first UE 120-1 may be preconfigured and/or hard-coded to implement sub-PRB interlacing. In some other aspects, the first UE 120-1 may receive an indication to implement sub-PRB interlacing. For example, the network node 110 may transmit, and the first UE 120-1 may receive, an indication that the first UE 120-1 should implement sub-PRB interlacing via an RRC communication. In some aspects, the indication that the first UE 120-1 should implement sub-PRB interlacing may be received via the configuration information described in connection with reference number 1205, while, in some other aspects, the indication that the first UE 120-1 should implement sub-PRB interlacing may be received via a different RRC communication, or the like. Additionally, or alternatively, the first UE 120-1 may receive an indication of a specific sub-PRB interlace to use for a given feedback communication. For example, the network node 110 may transmit, and the first UE 120-1 may receive, an indication of the sub-PRB interlace via an RRC communication (e.g., via the configuration information described in connection with reference number 1205 or else via a different RRC communication), via a MAC-CE communication, and/or via a DCI communication.

Moreover, the feedback resource may be associated with multiple symbols within a slot, as described above in connection with FIG. 10. That is, the feedback resource may span multiple contiguous symbols within a slot. For example, the feedback resource may be associated with M contiguous symbols located prior to a last gap symbol within a slot, such as the gap symbol shown and described in connection with FIG. 7. In some aspects, a quantity of the multiple contiguous symbols (e.g., M) may be preconfigured, else the quantity of contiguous symbols may be indicated via a RRC communication, such as the communication shown and described in connection with reference number 1205.

Moreover, in some aspects, the quantity of contiguous symbols may be associated with a resource pool associated with the feedback communication (e.g., the quantity of PSFCH symbols within a slot may be RRC configured at the resource pool level). Additionally, or alternatively, in some aspects, the configuration information may include a configuration of a resource pool associated with the feedback communication. Moreover, in some aspects, a size of the resource pool may be based at least in part on a CDM scheme applied to the feedback information. For example, in some aspects, in addition to being transmitted using sub-PRB interlacing (as described in more detail below), feedback information may be generated using a CDM scheme, such as an eight-level CDM scheme. Accordingly, because a feedback communication may be repeated eight times to accommodate the eight-level CDM scheme, including multiple times in the frequency domain and/or multiple times in the time domain, the network node 110 may configure a relatively large resource pool to accommodate for the eight-level CDM scheme.

The first UE 120-1 may configure itself based at least in part on the configuration information. In some aspects, the first UE 120-1 may be configured to perform one or more operations described herein based at least in part on the configuration information.

As shown by reference number 1210, the second UE 120-2 may transmit, and the first UE 120-1 may receive, a sidelink data communication. For example, the UE 120-2 may transmit a communication associated with a PSSCH, as described in connection with FIGS. 4-6. Moreover, in some aspects, the first UE 120-1 may be configured to provide a feedback communication associated with the sidelink data communication, such as an HARQ-ACK communication associated with the sidelink data communication. Accordingly, and as shown by reference number 1215, the first UE 120-1 may generate a feedback communication based at least in part on whether the sidelink data communication was safely received and decoded by the first UE 120-1. In some aspects, generating the feedback communication may include mapping the sidelink data communication described in connection with reference number 1210 to the corresponding sub-PRB interlace for providing the feedback communication. Moreover, in some aspects, the feedback communication may be further based at least in part on using CDM to generate the feedback communication, such as by using eight-level CDM as described in detail above in connection with FIGS. 10-11C. In such aspects, as shown by reference number 1215, the first UE 120-1 may use a CDM scheme to generate the feedback communication associated with the sidelink data communication, such as an eight-level CDM scheme.

As shown by reference number 1220, the first UE 120-1 may transmit, and the second UE 120-2 may receive, a feedback communication associated with the sidelink data communication. In some aspects, the first UE 120-1 may transmit the feedback communication associated with a sidelink data communication using a feedback resource configured by the configuration information described above in connection with reference number 1205. For example, the feedback resource may be associated with a PSFCH 1225, and thus the first UE 120-1 may transmit the feedback communication in the PSFCH 1225, as shown in FIG. 12. In some aspects, transmitting the feedback communication may be based at least in part on transmitting feedback information in a sub-PRB interlace, of the multiple sub-PRB interlaces, which is described in more detail below in connection with FIGS. 13A-13B.

In some aspects, transmitting the feedback communication may be based at least in part on using a CDM scheme to generate the feedback communication, as described in connection with reference number 1215. For example, in some aspects, transmitting the feedback communication may be based at least in part on using an eight-level CDM scheme to generate the feedback communication, such as one of the eight-level CDM schemes described above in connection with FIGS. 10-11C. In such aspects, the multiple sub-PRB interlaces may include two sub-PRB interlaces within one PRB, wherein each sub-PRB interlace within the one PRB is associated with six contiguous resource elements, which is described in more detail below in connection with FIG. 13A. In some other aspects, transmitting the feedback communication may be based at least in part on using four-level code division multiplexing and four-level frequency division multiplexing to generate the feedback communication. In such aspects, the multiple sub-PRB interlaces may include four sub-PRB interlaces within one PRB, wherein each sub-PRB interlace within the one PRB is associated with three contiguous resource elements, which is described in more detail below in connection with FIG. 13B.

As indicated above, FIG. 12 is provided as an example. Other examples may differ from what is described with respect to FIG. 12.

FIGS. 13A-13B are diagrams illustrating an example 1300 associated with a feedback resource associated with a sub-PRB interlace, in accordance with the present disclosure.

First, FIG. 13A shows an example in which two sub-PRB interlaces are included in one PRB. In this example, the two sub-PRB interlaces may be combined with an eight-level CDM scheme (such as one of the eight-level CDM schemes described in connection with FIGS. 10-11C) in order to include up to eight unique feedback communications per sub-PRB interlace. More particularly a first set of six REs, shown with PSFCH data symbols a(n) and including eight associated DMRS REs, may be associated with a first UE 120 or a first set of UEs 120 providing feedback (e.g., may be associated with a first set of eight unique feedback communications, indicated as UE1-UE8 in FIG. 13A), and a second set of six REs, shown with PSFCH data symbols i(n) and including eight associated DMRS REs, may be associated with a second UE 120 or a second set of UEs 120 providing feedback (e.g., may be associated with a second set of eight unique feedback communications, indicated as UE9-UE16 in FIG. 13A). Put another way, in this example, the number of contiguous REs associated with each sub-PRB interlace is six, so two sets of UEs 120 may be multiplexed within a single PRB. In this example, the eight-level CDM scheme is associated with a four-level TD-OCC scheme and a two-level FD-OCC scheme. Accordingly, PSFCH data symbols may be repeated four times in the time domain and feedback information may be repeated two times in the frequency domain, as described above in connection with FIG. 11A.

More particularly, the feedback resource example shown in FIG. 13A includes a resource grid 1302 including five symbols in the time domain, and 12 REs in the frequency domain (e.g., one PRB in the frequency domain). The five symbols in the time domain include an AGC symbol 1304 and four PSFCH symbols 1306, shown as 1306-1, 1306-2, 1306-3, and 1306-4. The feedback resource may be capable of frequency division multiplexing feedback information, shown as the unshaded REs in FIG. 13A, with DMRS information, shown using cross-hatching in FIG. 13A. Put another way, a feedback communication that is transmitted using the structure shown in FIG. 13A includes DMRS information that is frequency division multiplexed with feedback information.

Moreover, the feedback resource example shown in FIG. 13A may include multiple sets of feedback information or PSFCH data symbols, shown as a(n) and i(n) in FIG. 13A. The sets of feedback information or PSFCH data symbols indicated using a(n) may be associated with a first sub-PRB interlace, and the sets of feedback information or PSFCH data symbols indicated using i(n) may be associated with a second sub-PRB interlace. Put another way, the sets of feedback information or PSFCH data symbols indicated using a(n) may be used to convey feedback information for a first UE 120 and/or a first set of UEs 120 (indicated using UE1-UE8 in FIG. 13A), and the sets of feedback information or PSFCH data symbols indicated using i(n) may be used to convey feedback information for a second UE 120 and/or a second set of UEs 120 (indicated using UE9-UE16 in FIG. 13A). As shown, each set of PSFCH data symbols (e.g., a(n) and i(n)) may be repeated four times in the time domain, and two times in the frequency domain. Moreover, as indicated by reference number 1308, a four-level TD-OCC scheme may be applied to each set of PSFCH data symbols, and, as indicated by reference number 1310, a two-level FD-OCC scheme may be applied to each set of PSFCH data symbols, resulting in an eight-level CDM scheme being applied to each set of PSFCH data symbols. In this regard, four sets of the PSFCH data symbols (e.g., a(0), a(1), i(0), and i(1)), may be transmitted in the resource grid 1302, as shown.

Moreover, a feedback communication transmitted using the depicted structure may include DMRS information (e.g., the cross-hatched REs) that is frequency division multiplexed with feedback information (e.g., the unshaded REs), as described. In some aspects, the TD-OCC scheme and the FD-OCC scheme that are applied to the feedback information associated with each sub-PRB interlace (e.g., the TD-OCC scheme and the FD-OCC scheme that are applied to each set of PSFCH data symbols, a(n) and i(n)) are also applied to the DMRS information. More particularly, as shown by reference number 1312, the four-level TD-OCC scheme may be applied to the DMRS information (e.g., a legacy DMRS sequence), and, as shown by reference number 1314, the two-level FD-OCC scheme may also be applied to the DMRS information. Applying the eight-level CDM scheme (which, in this aspect, includes the four-level TD-OCC scheme and the two-level FD-OCC scheme) to the DMRS information may beneficially orthogonalize the DMRS sequences transmitted by one or more UEs 120.

FIG. 13B shows an example in which four sub-PRB interlaces are included in one PRB. For example, in some aspects, a constant channel may not be able to be guaranteed in a half of the PRB (e.g., 6 REs), and thus the performance of an eight-level CDM scheme may be degraded. Accordingly, a four-level CDM scheme, together with a four-level frequency domain multiplexing (FDM) scheme, may be implemented in order to achieve multiplexing of 16 UEs or sets of UEs in a PRB (indicated using UE1-UE16 in FIG. 13B). More particularly, a first set of three REs, shown with PSFCH data symbols a(0) and including four associated DMRS REs, may be associated with a first set of feedback communications (e.g., may be associated with a first set of four unique feedback communications, indicated as UE1-UE4 in FIG. 13B); a second set of three REs, shown with PSFCH data symbols b(0) and including four associated DMRS REs, may be associated with a second set of feedback communications (e.g., may be associated with a second set of four unique feedback communications, indicated as UE5-UE8 in FIG. 13B); a third set of three REs, shown with PSFCH data symbols c(0) and including four associated DMRS REs, may be associated with a third set of feedback communications (e.g., may be associated with a third set of four unique feedback communications, indicated as UE9-UE12 in FIG. 13B); and a fourth set of three REs, shown with PSFCH data symbols d(0) and including four associated DMRS REs, may be associated with a fourth set of feedback communications (e.g., may be associated with a fourth set of four unique feedback communications, indicated as UE13-UE16 in FIG. 13B). Put another way, in this example, the number of contiguous REs associated with each sub-PRB interlace is three, so four sets of UEs 120 may be multiplexed within a single PRB. In this example, the four-level CDM scheme is associated with a four-level TD-OCC scheme. Accordingly, PSFCH data symbols may be repeated four times in the time domain.

More particularly, the feedback resource example shown in FIG. 13B includes a resource grid 1316 including five symbols in the time domain, and 12 REs in the frequency domain (e.g., one PRB in the frequency domain). The five symbols in the time domain include an AGC symbol 1318, and four PSFCH symbols 1320, shown as 1320-1, 1320-2, 1320-3, and 1320-4. The feedback resource may be capable of frequency division multiplexing feedback information, shown as the unshaded REs in FIG. 13B, with DMRS information, shown using cross-hatching in FIG. 13B. Put another way, a feedback communication that is transmitted using the structure shown in FIG. 13B includes DMRS information that is frequency division multiplexed with feedback information.

Moreover, the feedback resource example shown in FIG. 13B may include multiple sets of feedback information or PSFCH data symbols, shown as a(0), b(0), c(0), and d(0) in FIG. 13B. The sets of feedback information or PSFCH data symbols indicated using a(0) may be associated with a first sub-PRB interlace, the sets of feedback information or PSFCH data symbols indicated using b(0) may be associated with a second sub-PRB interlace, the sets of feedback information or PSFCH data symbols indicated using c(0) may be associated with a third sub-PRB interlace, and the sets of feedback information or PSFCH data symbols indicated using d(0) may be associated with a fourth sub-PRB interlace. Put another way, the sets of feedback information or PSFCH data symbols indicated using a(0) may be used to convey feedback information for a first UE 120 and/or a first set of UEs 120 (indicated using UE1-UE4 in FIG. 13B), the sets of feedback information or PSFCH data symbols indicated using b(0) may be used to convey feedback information for a second UE 120 and/or a second set of UEs 120 (indicated using UE5-UE8 in FIG. 13B), the sets of feedback information or PSFCH data symbols indicated using c(0) may be used to convey feedback information for a third UE 120 and/or a third set of UEs 120 (indicated using UE9-UE12 in FIG. 13B), and the sets of feedback information or PSFCH data symbols indicated using d(0) may be used to convey feedback information for a fourth UE 120 and/or a fourth set of UEs 120 (indicated using UE13-UE16 in FIG. 13B). As shown, each set of PSFCH data symbols (e.g., a(0), b(0), c(0), and d(0)) may be repeated four times in the time domain. Moreover, as indicated by reference number 1322, a four-level TD-OCC scheme may be applied to the set of PSFCH data symbols, resulting in a four-level CDM scheme being applied to each set of PSFCH data symbols (e.g., resulting in an increase in PSFCH multiplexing capacity by four times). Combined with four-level frequency domain multiplexing, the four-level CDM scheme may result in an increase in PSFCH multiplexing capacity by sixteen times.

Moreover, a feedback communication transmitted using the depicted structure may include DMRS information (e.g., the cross-hatched REs) that is frequency division multiplexed with feedback information (e.g., the unshaded REs), as described. In some aspects, the TD-OCC scheme that is applied to the feedback information (e.g., the TD-OCC scheme and the FD-OCC scheme that are applied to feedback information associated with each sub-PRB interlace (e.g., the TD-OCC scheme that is applied to each set of PSFCH data symbols, a(0), b(0), c(0), and d(0)) may also be applied to the DMRS information. More particularly, as shown by reference number 1324, the four-level TD-OCC scheme may be applied to the DMRS information (e.g., a legacy DMRS sequence). Applying the four-level CDM scheme (which, in this aspect, includes the four-level TD-OCC scheme) to the DMRS information may beneficially orthogonalize the DMRS sequences transmitted by one or more UEs 120.

As indicated above, FIGS. 13A-13B are provided as an example. Other examples may differ from what is described with respect to FIGS. 13A-13B.

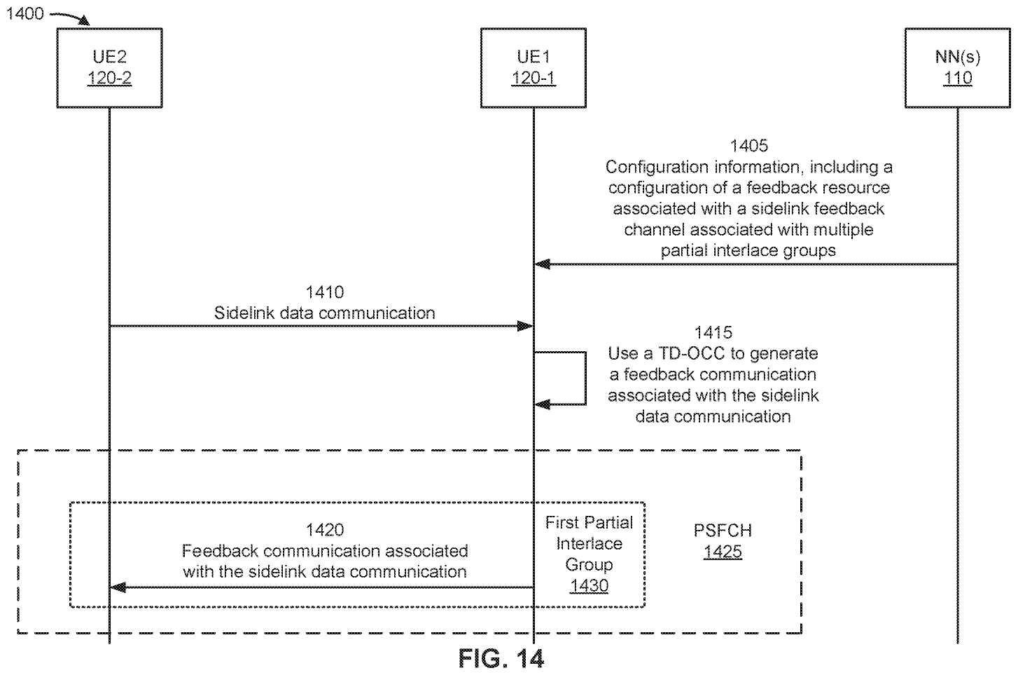

FIG. 14 is a diagram of an example 1400 associated with a feedback resource associated with a partial interlace group, in accordance with the present disclosure. As shown in FIG. 14, a network node 110 may communicate with a first UE 120-1 (e.g., UE 120), and/or the first UE 120-1 may communicate with a second UE 120-2 (e.g., UE 120). For example, the network node 110 may communicate with the first UE 120-1 via an access link, such as one of the access links described in connection with FIG. 5, and the first UE 120-1 may communicate with the second UE 120-2 via a sidelink, such as the sidelink described in connection with FIG. 5. In some aspects, the network node 110, the first UE 120-1, and the second UE 120-2 may be part of a wireless network (e.g., wireless network 100). The network node 110, the first UE 120-1, and the second UE 120-2 may have established a wireless connection prior to operations shown in FIG. 10. For example, the network node 110 and the first UE 120-1 may have established a wireless connection via a Uu interface, and the first UE 120-1 and the second UE 120-2 may have established a wireless connection via a PC5 interface.

As shown by reference number 1405, the network node 110 may transmit, and the first UE 120-1 may receive, configuration information. In some aspects, the first UE 120-1 may receive the configuration information via one or more of RRC signaling, one or more MAC-CEs, and/or DCI, among other examples. In some aspects, the configuration information may include an indication of one or more configuration parameters (e.g., already known to the first UE 120-1 and/or previously indicated by the network node 110 or other network device) for selection by the first UE 120-1, and/or explicit configuration information for the first UE 120-1 to use to configure the first UE 120-1, among other examples. In some aspects, the network node 110 may transmit the configuration information to one or more additional UEs 120. For example, in some aspects, the network node 110 may also transmit the configuration information to the second UE 120-2.

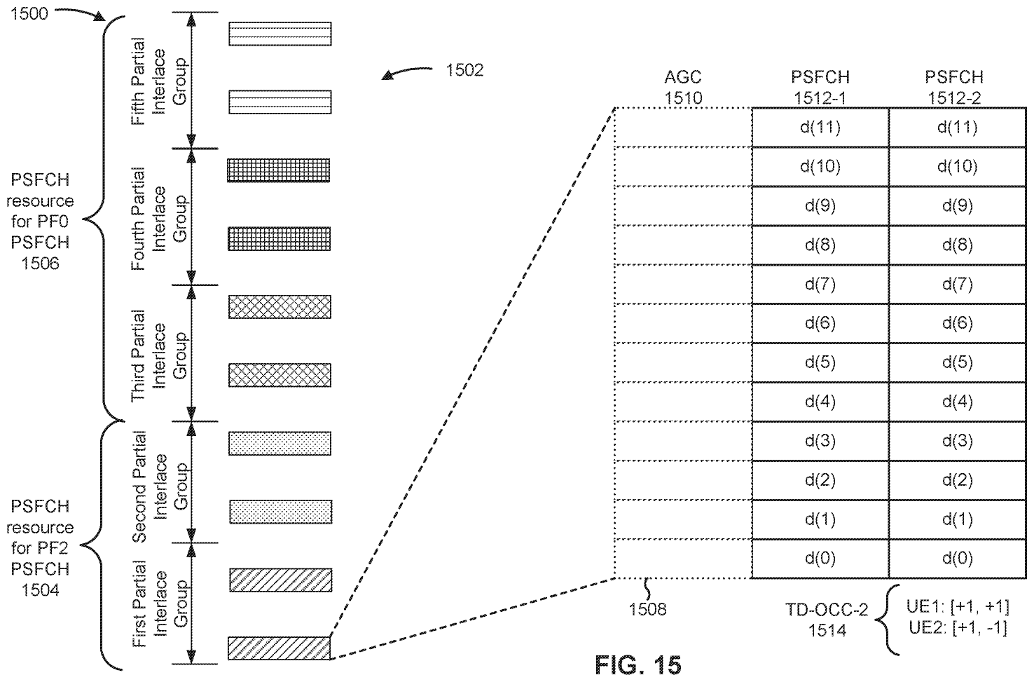

In some aspects, the configuration information may include a configuration of a feedback resource (e.g., a PSFCH resource) associated with a sidelink feedback channel (e.g., a PSFCH), wherein the feedback resource is associated with multiple partial interlace groups. Moreover, in some aspects, the feedback communication may be associated with one or more feedback communication structures described above in connection with FIGS. 6-9. For example, in some aspects, the feedback communication may be associated with a PSFCH format 0 communication and/or a PSFCH format 2 communication. More particularly, a first subset of the multiple partial interlace groups may be associated with a PSFCH format 0 communication, and a second subset of the multiple partial interlace groups may be associated with a PSFCH format 2 communication, which is described in more detail in connection with FIG. 15.

Moreover, in some aspects, the feedback communication may be associated with a TD-OCC scheme, such as a two-level TD-OCC scheme. Accordingly, the feedback resource may be associated with multiple symbols within a slot. That is, the feedback resource may span multiple contiguous symbols within a slot. For example, the feedback resource may be associated with M contiguous symbols (e.g., two in the example depicted in FIG. 15) located prior to a last gap symbol within a slot, such as the gap symbol shown and described in connection with FIG. 7. In some aspects, a quantity of the multiple contiguous symbols (e.g., M) may be preconfigured, else the quantity of contiguous symbols may be indicated via a RRC communication, such as the communication shown and described in connection with reference number 1405.

Moreover, in some aspects, the quantity of contiguous symbols may be associated with a resource pool associated with the feedback communication (e.g., the quantity of PSFCH symbols within a slot may be RRC configured at the resource pool level). Additionally, or alternatively, in some aspects, the configuration information may include a configuration of a resource pool associated with the feedback communication. Moreover, in some aspects, a size of the resource pool may be based at least in part on at least in part on a number of levels associated with a TD-OCC scheme associated with a feedback communication. For example, because a feedback communication may be repeated two or four times to accommodate a two-level or four-level TD-OCC CDM scheme, respectively, the network node 110 may configure a relatively large resource pool to accommodate for the two-level or four-level TD-OCC scheme.

The first UE 120-1 may configure itself based at least in part on the configuration information. In some aspects, the first UE 120-1 may be configured to perform one or more operations described herein based at least in part on the configuration information.

As shown by reference number 1410, the second UE 120-2 may transmit, and the first UE 120-1 may receive, a sidelink data communication. For example, the UE 120-2 may transmit a communication associated with a PSSCH, as described in connection with FIGS. 4-6. Moreover, in some aspects, the first UE 120-1 may be configured to provide a feedback communication associated with the sidelink data communication, such as an HARQ-ACK communication associated with the sidelink data communication. Accordingly, and as shown by reference number 1415, the first UE 120-1 may use a TD-OCC scheme to generate a feedback communication associated with the sidelink data communication. In some aspects, the first UE 120-1 may use a two-level TD-OCC scheme to generate the feedback communication associated with the sidelink data communication, and, in some other aspects, the first UE 120-1 may use a four-level TD-OCC scheme to generate the feedback communication associated with the sidelink data communication.

As shown by reference number 1420, the first UE 120-1 may transmit, and the second UE 120-2 may receive, a feedback communication associated with the sidelink data communication. In some aspects, the first UE 120-1 may transmit the feedback communication associated with a sidelink data communication using a feedback resource configured by the configuration information described above in connection with reference number 1405. For example, the feedback resource may be associated with a PSFCH 1425, and thus the first UE 120-1 may transmit the feedback communication in the PSFCH 1425, as shown in FIG. 10. Moreover, the PSFCH 1425 may be associated with multiple partial interlace groups, as described. Thus, the first UE 120-1 may transmit the feedback communication using a first partial interlace group 1430 associated with the PSFCH 1425, as shown in FIG. 10. In some aspects, transmitting the feedback communication may be based at least in part on transmitting feedback information in a first partial interlace group, of the multiple partial interlace groups, and generating the feedback communication based at least in part on using a TD-OCC scheme. Additional aspects of a feedback resource associated with a partial interlace and a TD-OCC scheme are described in more detail below in connection with FIG. 15.

As indicated above, FIG. 14 is provided as an example. Other examples may differ from what is described with respect to FIG. 14.

FIG. 15 is a diagram illustrating an example 1500 associated with a feedback resource associated with a partial interlace, in accordance with the present disclosure.

FIG. 15 shows an example in which multiple partial interlace groups are associated with a single interlace, such as the structure described in connection with FIG. 9. In this example, the partial interlace structure may be combined with a CDM scheme, such as a TD-OCC scheme, in order to increase feedback capacity in a partial interlace group. More particularly, in the depicted example, the feedback communication may be associated with a two-level TD-OCC scheme, and thus PSFCH data symbols, shown as d(n) in FIG. 15, may be repeated two times in the time domain. In some other aspects, the feedback communication may be associated with a difference CDM scheme, such as a four-level TD-OCC scheme.

More particularly, the feedback resource example shown in FIG. 15 includes a partial interlace structure 1502, in which an interlace (such as the interlace described in connection with FIG. 7) may be associated with multiple partial interlace groups, such as the first through fifth partial interlace groups. In some aspects, a first subset of the multiple partial interlace groups may be associated with a PSFCH format 0 communication, and a second subset of the multiple partial interlace groups may be associated with a PSFCH format 2 communication. For example, as indicated by reference number 1504, the first and second partial interlace group may be associated with a PSFCH format 2 communication, and, as indicated by reference number 1506, the third, fourth, and fifth partial interlace groups may be associated with a PSFCH format 0 communication.

Each partial interlace group may further be associated with a CDM scheme, such as a TD-OCC scheme. For example, the first partial interlace group may be associated with a resource grid 1508, which includes three symbols in the time domain, and 12 REs in the frequency domain (e.g., one PRB in the frequency domain). The three symbols in the time domain include an AGC symbol 1510 and two PSFCH symbols 1512, shown as 1512-1 and 1512-2. In some aspects, for partial interlace groups associated with a PSFCH format 2 communication, the feedback resource may be capable of frequency division multiplexing feedback information with DMRS information, such as was described in more detail in connection with FIG. 8.

Moreover, the feedback resource example shown in FIG. 15 may include multiple sets of feedback information or PSFCH data symbols, shown as d(n) in FIG. 15. As shown, each set of PSFCH data symbols (e.g., d(n)) may be repeated two times in the time domain, because the example shown is associated with two-level TD-OCC, as shown by reference number 1514. In some other aspects, each set of PSFCH data symbols may be repeated more or less in the time domain to accommodate other TD-OCC schemes. For example, each set of PSFCH data symbols (e.g., d(n)) may be repeated four times in the time domain when four-level TD-OCC is implemented.

Based at least in part on first UE 120-1 transmitting a feedback communication using one of the structures described in connection with FIGS. 10-15, the first UE 120-1 and/or the network node 110 may conserve computing, power, network, and/or communication resources that may have otherwise been consumed using other sidelink feedback procedures. For example, based at least in part on first UE 120-1 transmitting a feedback communication using one of the structures described in connection with FIGS. 10-15, sidelink feedback capacity may be increased, thus providing more robust feedback information to the UEs 120-1, 120-2 communicating in the sidelink, and the first UE 120-1 and the second UE 120-2 may communicate with a reduced error rate, which may conserve computing, power, network, and/or communication resources that may have otherwise been consumed to detect and/or correct communication errors.

As indicated above, FIG. 15 is provided as an example. Other examples may differ from what is described with respect to FIG. 15.

FIG. 16 is a diagram illustrating an example process 1600 performed, for example, by a UE, in accordance with the present disclosure. Example process 1600 is an example where the UE (e.g., UE 120) performs operations associated with capacity enhancement for a sidelink feedback channel.

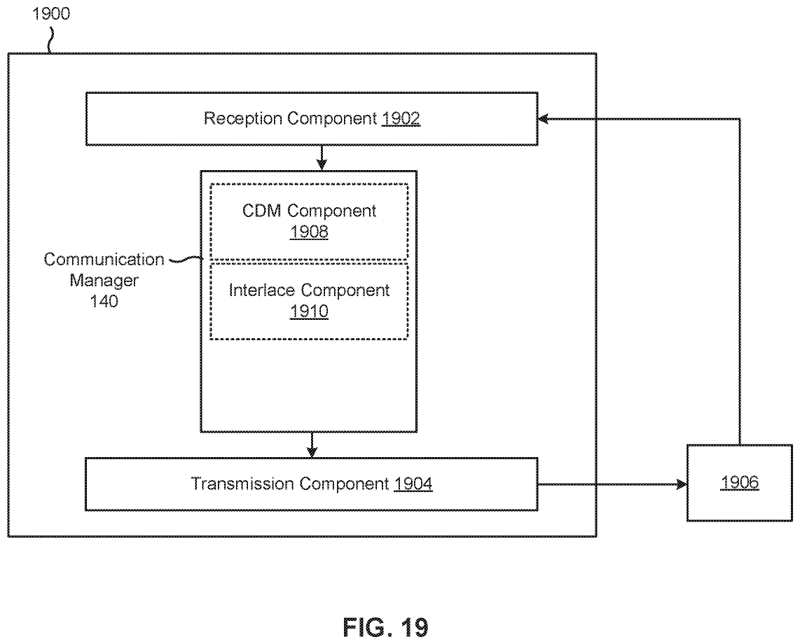

As shown in FIG. 16, in some aspects, process 1600 may include receiving a configuration of a feedback resource associated with a sidelink feedback channel, wherein the feedback resource is associated with an eight-level CDM scheme (block 1610). For example, the UE (e.g., using communication manager 140 and/or reception component 1902, depicted in FIG. 19) may receive a configuration of a feedback resource associated with a sidelink feedback channel, wherein the feedback resource is associated with an eight-level CDM scheme, as described above.

As further shown in FIG. 16, in some aspects, process 1600 may include transmitting a feedback communication associated with a sidelink data communication using the feedback resource, wherein transmitting the feedback communication is based at least in part on using the eight-level CDM scheme to generate the feedback communication (block 1620). For example, the UE (e.g., using communication manager 140, transmission component 1904, and/or CDM component 1908, depicted in FIG. 19) may transmit a feedback communication associated with a sidelink data communication using the feedback resource, wherein transmitting the feedback communication is based at least in part on using the eight-level CDM scheme to generate the feedback communication, as described above.

Process 1600 may include additional aspects, such as any single aspect or any combination of aspects described below and/or in connection with one or more other processes described elsewhere herein.

In a first aspect, the feedback communication is associated with a physical sidelink feedback channel format 2 communication.

In a second aspect, alone or in combination with the first aspect, the feedback resource spans multiple contiguous symbols within a slot.

In a third aspect, alone or in combination with one or more of the first and second aspects, a quantity of the multiple contiguous symbols is either preconfigured or indicated via a radio resource control communication and associated with a resource pool associated with the feedback communication.

In a fourth aspect, alone or in combination with one or more of the first through third aspects, process 1600 includes receiving a configuration of a resource pool associated with the feedback communication, wherein a size of the resource pool is based at least in part on the eight-level CDM scheme.

In a fifth aspect, alone or in combination with one or more of the first through fourth aspects, the eight-level CDM scheme is associated with a TD-OCC scheme and an FD-OCC scheme.

In a sixth aspect, alone or in combination with one or more of the first through fifth aspects, the eight-level CDM scheme is associated with one of a two-level TD-OCC scheme and a four-level FD-OCC scheme, or a four-level TD-OCC scheme and a two-level FD-OCC scheme.

In a seventh aspect, alone or in combination with one or more of the first through sixth aspects, the feedback communication includes DMRS information that is frequency division multiplexed with feedback information, and the TD-OCC scheme and the FD-OCC scheme are applied to both the DMRS information and the feedback information.

In an eighth aspect, alone or in combination with one or more of the first through seventh aspects, the eight-level CDM scheme is associated with a first-step FD-OCC scheme and a second-step FD-OCC scheme.

In a ninth aspect, alone or in combination with one or more of the first through eighth aspects, the first-step FD-OCC scheme is associated with a two-level FD-OCC scheme, and the second-step FD-OCC scheme is associated with a four-level FD-OCC scheme.

In a tenth aspect, alone or in combination with one or more of the first through ninth aspects, the feedback communication includes DMRS information that is frequency division multiplexed with feedback information, the first-step FD-OCC scheme and the second-step FD-OCC scheme are applied to the feedback information, and a TD-OCC scheme and another FD-OCC scheme are applied to the DMRS information.

In an eleventh aspect, alone or in combination with one or more of the first through tenth aspects, process 1600 includes transmitting the feedback communication using a scheduled interlace associated with the feedback resource, wherein the scheduled interlace is associated with multiple non-contiguous PRBs.

In a twelfth aspect, alone or in combination with one or more of the first through eleventh aspects, the eight-level CDM scheme is associated with an FD-OCC scheme, and the feedback communication is transmitted using FD-OCC cycling such that an FD-OCC sequence changes between subsequent PRBs, of the multiple non-contiguous PRBs.

In a thirteenth aspect, alone or in combination with one or more of the first through twelfth aspects, an FD-OCC sequence index associated with a corresponding FD-OCC sequence in a corresponding PRB, of the multiple non-contiguous PRBs, is determined based at least in part on an FD-OCC-cycling formula.

In a fourteenth aspect, alone or in combination with one or more of the first through thirteenth aspects, the FD-OCC-cycling formula is based at least in part on a length of the corresponding FD-OCC sequence and an initial FD-OCC sequence index.

In a fifteenth aspect, alone or in combination with one or more of the first through fourteenth aspects, the initial FD-OCC sequence index is at least one of indicated via a radio resource control communication, based at least in part on a source identifier associated with the feedback resource, based at least in part on a zone identifier associated with the feedback resource, or indicated via a sidelink control information message.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by an UE, in accordance with the present disclosure. Example process 1700 is an example where the UE (e.g., UE 120) performs operations associated with capacity enhancement for a sidelink feedback channel.

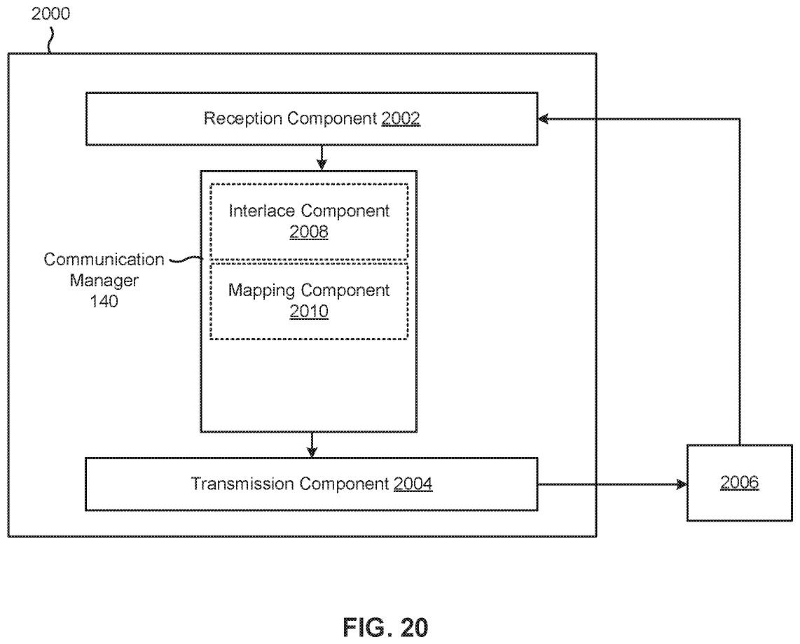

As shown in FIG. 17, in some aspects, process 1700 may include receiving a configuration of a feedback resource associated with a sidelink feedback channel, wherein the feedback resource is associated with multiple sub-PRB interlaces (block 1710). For example, the UE (e.g., using communication manager 140 and/or reception component 2002, depicted in FIG. 20) may receive a configuration of a feedback resource associated with a sidelink feedback channel, wherein the feedback resource is associated with multiple sub-PRB interlaces, as described above.

As further shown in FIG. 17, in some aspects, process 1700 may include transmitting a feedback communication associated with a sidelink data communication using the feedback resource, wherein transmitting the feedback communication is based at least in part on transmitting feedback information in a sub-PRB interlace, of the multiple sub-PRB interlaces (block 1720). For example, the UE (e.g., using communication manager 140, transmission component 2004, and/or interlace component 2008, depicted in FIG. 20) may transmit a feedback communication associated with a sidelink data communication using the feedback resource, wherein transmitting the feedback communication is based at least in part on transmitting feedback information in a sub-PRB interlace, of the multiple sub-PRB interlaces, as described above.

Process 1700 may include additional aspects, such as any single aspect or any combination of aspects described below and/or in connection with one or more other processes described elsewhere herein.

In a first aspect, transmitting the feedback communication is further based at least in part on using eight-level code division multiplexing to generate the feedback communication.

In a second aspect, alone or in combination with the first aspect, the multiple sub-PRB interlaces include two sub-PRB interlaces within one PRB, wherein each sub-PRB interlace within the one PRB is associated with six contiguous resource elements.

In a third aspect, alone or in combination with one or more of the first and second aspects, transmitting the feedback communication is further based at least in part on using four-level code division multiplexing and four-level frequency division multiplexing to generate the feedback communication.

In a fourth aspect, alone or in combination with one or more of the first through third aspects, the multiple sub-PRB interlaces include four sub-PRB interlaces within one PRB, wherein each sub-PRB interlace within the one PRB is associated with three contiguous resource elements.

In a fifth aspect, alone or in combination with one or more of the first through fourth aspects, an indication of whether to implement sub-PRB interlacing is either preconfigured at the UE or indicated via a radio resource control communication.

In a sixth aspect, alone or in combination with one or more of the first through fifth aspects, process 1700 includes receiving an indication of the sub-PRB interlace.

In a seventh aspect, alone or in combination with one or more of the first through sixth aspects, process 1700 includes mapping a sidelink data communication to the sub-PRB interlace.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a UE, in accordance with the present disclosure. Example process 1800 is an example where the UE (e.g., UE 120) performs operations associated with capacity enhancement for a sidelink feedback channel.

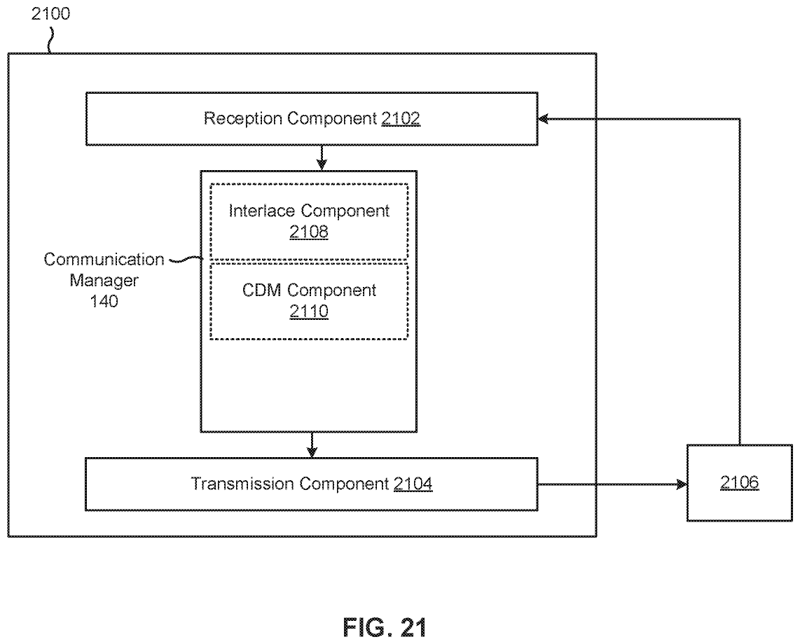

As shown in FIG. 18, in some aspects, process 1800 may include receiving a configuration of a feedback resource associated with a sidelink feedback channel, wherein the feedback resource is associated with multiple partial interlace groups (block 1810). For example, the UE (e.g., using communication manager 140 and/or reception component 2102, depicted in FIG. 21) may receive a configuration of a feedback resource associated with a sidelink feedback channel, wherein the feedback resource is associated with multiple partial interlace groups, as described above.

As further shown in FIG. 18, in some aspects, process 1800 may include transmitting a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme (block 1820). For example, the UE (e.g., using communication manager 140, transmission component 2104, interlace component 2108, and/or CDM component 2110, depicted in FIG. 21) may transmit a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme, as described above.

Process 1800 may include additional aspects, such as any single aspect or any combination of aspects described below and/or in connection with one or more other processes described elsewhere herein.

In a first aspect, a first subset of the multiple partial interlace groups are associated with a PSFCH format 0 communication, and wherein a second subset of the multiple partial interlace groups are associated with a PSFCH format 2 communication.

In a second aspect, alone or in combination with the first aspect, the TD-OCC scheme is one of a two-level TD-OCC scheme or a four-level TD-OCC scheme.

In a third aspect, alone or in combination with one or more of the first and second aspects, process 1800 includes receiving a configuration of a resource pool associated with the feedback communication, wherein a size of the resource pool is based at least in part on a number of levels associated with the TD-OCC scheme.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a UE (e.g., UE 120), or a UE may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE 120, a network node 110, or another wireless communication device) using the reception component 1902 and the transmission component 1904. As further shown, the apparatus 1900 may include the communication manager 140. The communication manager 140 may include a CDM component 1908, or an interlace component 1910, among other examples.

In some aspects, the apparatus 1900 may be configured to perform one or more operations described herein in connection with FIGS. 10-15. Additionally, or alternatively, the apparatus 1900 may be configured to perform one or more processes described herein, such as process 1600 of FIG. 16. In some aspects, the apparatus 1900 and/or one or more components shown in FIG. 19 may include one or more components of the UE 120 described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the UE 120 described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the UE 120 described in connection with FIG. 2. In some aspects, the transmission component 1904 may be co-located with the reception component 1902 in a transceiver.

The reception component 1902 may receive a configuration of a feedback resource associated with a sidelink feedback channel, wherein the feedback resource is associated with an eight-level CDM scheme. The transmission component 1904 and/or the CDM component 1908 may transmit a feedback communication associated with a sidelink data communication using the feedback resource, wherein transmitting the feedback communication is based at least in part on using the eight-level CDM scheme to generate the feedback communication.

The reception component 1902 may receive a configuration of a resource pool associated with the feedback communication, wherein a size of the resource pool is based at least in part on the eight-level CDM scheme.

The transmission component 1904 and/or the interlace component 1910 may transmit the feedback communication using a scheduled interlace associated with the feedback resource, wherein the scheduled interlace is associated with multiple non-contiguous PRBs.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a UE (e.g., UE 120), or a UE may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE 120, a network node 110, or another wireless communication device) using the reception component 2002 and the transmission component 2004. As further shown, the apparatus 2000 may include the communication manager 140. The communication manager 140 may include one or more of an interlace component 2008, or a mapping component 2010, among other examples.

In some aspects, the apparatus 2000 may be configured to perform one or more operations described herein in connection with FIGS. 10-15. Additionally, or alternatively, the apparatus 2000 may be configured to perform one or more processes described herein, such as process 1700 of FIG. 17. In some aspects, the apparatus 2000 and/or one or more components shown in FIG. 20 may include one or more components of the UE 120 described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a demodulator, a MIMO detector, a receive processor, a controller/processor, a memory, or a combination thereof, of the UE 120 described in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a modulator, a transmit MIMO processor, a transmit processor, a controller/processor, a memory, or a combination thereof, of the UE 120 described in connection with FIG. 2. In some aspects, the transmission component 2004 may be co-located with the reception component 2002 in a transceiver.

The reception component 2002 may receive a configuration of a feedback resource associated with a sidelink feedback channel, wherein the feedback resource is associated with multiple sub-PRB interlaces. The transmission component 2004 and/or the interlace component 2008 may transmit a feedback communication associated with a sidelink data communication using the feedback resource, wherein transmitting the feedback communication is based at least in part on transmitting feedback information in a sub-PRB interlace, of the multiple sub-PRB interlaces.

The reception component 2002 may receive an indication of the sub-PRB interlace.

The mapping component 2010 may map a sidelink data communication to the sub-PRB interlace.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

FIG. 21 is a diagram of an example apparatus 2100 for wireless communication, in accordance with the present disclosure. The apparatus 2100 may be a UE (e.g., UE 120), or a UE may include the apparatus 2100. In some aspects, the apparatus 2100 includes a reception component 2102 and a transmission component 2104, which may be in communication with one another (for example, via one or more buses and/or one or more other components). As shown, the apparatus 2100 may communicate with another apparatus 2106 (such as a UE 120, a network node 110, or another wireless communication device) using the reception component 2102 and the transmission component 2104. As further shown, the apparatus 2100 may include the communication manager 140. The communication manager 140 may include one or more of an interlace component 2108, or a CDM component 2110, among other examples.

In some aspects, the apparatus 2100 may be configured to perform one or more operations described herein in connection with FIGS. 10-15. Additionally, or alternatively, the apparatus 2100 may be configured to perform one or more processes described herein, such as process 1800 of FIG. 18. In some aspects, the apparatus 2100 and/or one or more components shown in FIG. 21 may include one or more components of the UE 120 described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2106. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a demodulator, a MIMO detector, a receive processor, a controller/processor, a memory, or a combination thereof, of the UE 120 described in connection with FIG. 2.

The transmission component 2104 may transmit communications, such as reference signals, control information, data communications, or a combination thereof, to the apparatus 2106. In some aspects, one or more other components of the apparatus 2100 may generate communications and may provide the generated communications to the transmission component 2104 for transmission to the apparatus 2106. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2106. In some aspects, the transmission component 2104 may include one or more antennas, a modem, a modulator, a transmit MIMO processor, a transmit processor, a controller/processor, a memory, or a combination thereof, of the UE 120 described in connection with FIG. 2. In some aspects, the transmission component 2104 may be co-located with the reception component 2102 in a transceiver.

The reception component 2102 may receive a configuration of a feedback resource associated with a sidelink feedback channel, wherein the feedback resource is associated with multiple partial interlace groups. The transmission component 2104, the interlace component 2108, and/or the CDM component 2110 may transmit a feedback communication associated with a sidelink data communication using the feedback resource, wherein transmitting the feedback communication is based at least in part on transmitting feedback information in a first partial interlace group, of the multiple partial interlace groups, and generating the feedback communication based at least in part on using a TD-OCC scheme.

The reception component 2102 may receive a configuration of a resource pool associated with the feedback communication, wherein a size of the resource pool is based at least in part on a number of levels associated with the TD-OCC scheme.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

The following provides an overview of some Aspects of the present disclosure:
Aspect 1: A method of wireless communication performed by a UE, comprising: receiving a configuration of a feedback resource associated with a sidelink feedback channel, wherein the feedback resource is associated with an eight-level CDM scheme; and transmitting a feedback communication associated with a sidelink data communication using the feedback resource, wherein transmitting the feedback communication is based at least in part on using the eight-level CDM scheme to generate the feedback communication.
Aspect 2: The method of Aspect 1, wherein the feedback communication is associated with a physical sidelink feedback channel format 2 communication.
Aspect 3: The method of any of Aspects 1-2, wherein the feedback resource spans multiple contiguous symbols within a slot.
Aspect 4: The method of Aspect 3, wherein a quantity of the multiple contiguous symbols is either preconfigured or indicated via a radio resource control communication and associated with a resource pool associated with the feedback communication.
Aspect 5: The method of any of Aspects 1-4, further comprising receiving a configuration of a resource pool associated with the feedback communication, wherein a size of the resource pool is based at least in part on the eight-level CDM scheme.
Aspect 6: The method of any of Aspects 1-5, wherein the eight-level CDM scheme is associated with a TD-OCC scheme and an FD-OCC scheme.
Aspect 7: The method of Aspect 6, wherein the eight-level CDM scheme is associated with one of: a two-level TD-OCC scheme and a four-level FD-OCC scheme, or a four-level TD-OCC scheme and a two-level FD-OCC scheme.
Aspect 8: The method of any of Aspects 6-7, wherein the feedback communication includes DMRS information that is frequency division multiplexed with feedback information, and wherein the TD-OCC scheme and the FD-OCC scheme are applied to both the DMRS information and the feedback information.
Aspect 9: The method of any of Aspects 1-5, wherein the eight-level CDM scheme is associated with a first-step FD-OCC scheme and a second-step FD-OCC scheme.
Aspect 10: The method of Aspect 9, wherein the first-step FD-OCC scheme is associated with a two-level FD-OCC scheme, and wherein the second-step FD-OCC scheme is associated with a four-level FD-OCC scheme.
Aspect 11: The method of any of Aspects 9-10, wherein the feedback communication includes DMRS information that is frequency division multiplexed with feedback information, wherein the first-step FD-OCC scheme and the second-step FD-OCC scheme are applied to the feedback information, and wherein a TD-OCC scheme and another FD-OCC scheme are applied to the DMRS information.
Aspect 12: The method of any of Aspects 1-11, further comprising transmitting the feedback communication using a scheduled interlace associated with the feedback resource, wherein the scheduled interlace is associated with multiple non-contiguous PRBs.
Aspect 13: The method of Aspect 12, wherein the eight-level CDM scheme is associated with an FD-OCC scheme, and wherein the feedback communication is transmitted using FD-OCC cycling such that an FD-OCC sequence changes between subsequent PRBs, of the multiple non-contiguous PRBs.
Aspect 14: The method of Aspect 13, wherein an FD-OCC sequence index associated with a corresponding FD-OCC sequence in a corresponding PRB, of the multiple non-contiguous PRBs, is determined based at least in part on an FD-OCC-cycling formula.
Aspect 15: The method of Aspect 14, wherein the FD-OCC-cycling formula is based at least in part on a length of the corresponding FD-OCC sequence and an initial FD-OCC sequence index.
Aspect 16: The method of Aspect 15, wherein the initial FD-OCC sequence index is at least one of: indicated via a radio resource control communication, based at least in part on a source identifier associated with the feedback resource, based at least in part on a zone identifier associated with the feedback resource, or indicated via a sidelink control information message.
Aspect 17: A method of wireless communication performed by a UE, comprising: receiving a configuration of a feedback resource associated with a sidelink feedback channel, wherein the feedback resource is associated with multiple sub-PRB interlaces; and transmitting a feedback communication associated with a sidelink data communication using the feedback resource, wherein transmitting the feedback communication is based at least in part on transmitting feedback information in a sub-PRB interlace, of the multiple sub-PRB interlaces.
Aspect 18: The method of Aspect 17, wherein transmitting the feedback communication is further based at least in part on using eight-level code division multiplexing to generate the feedback communication.
Aspect 19: The method of Aspect 18, wherein the multiple sub-PRB interlaces include two sub-PRB interlaces within one PRB, wherein each sub-PRB interlace within the one PRB is associated with six contiguous resource elements.
Aspect 20: The method of Aspect 17, wherein transmitting the feedback communication is further based at least in part on using four-level code division multiplexing and four-level frequency division multiplexing to generate the feedback communication.
Aspect 21: The method of Aspect 20, wherein the multiple sub-PRB interlaces include four sub-PRB interlaces within one PRB, wherein each sub-PRB interlace within the one PRB is associated with three contiguous resource elements.
Aspect 22: The method of any of Aspects 17-21, wherein an indication of whether to implement sub-PRB interlacing is either preconfigured at the UE or indicated via a radio resource control communication.
Aspect 23: The method of any of Aspects 17-22, further comprising receiving an indication of the sub-PRB interlace.
Aspect 24: The method of Aspect 23, further comprising mapping a sidelink data communication to the sub-PRB interlace.
Aspect 25: A method of wireless communication performed by a UE, comprising: receiving a configuration of a feedback resource associated with a sidelink feedback channel, wherein the feedback resource is associated with multiple partial interlace groups; and transmitting a feedback communication associated with a sidelink data communication using the feedback resource, wherein transmitting the feedback communication is based at least in part on: transmitting feedback information in a first partial interlace group, of the multiple partial interlace groups, and generating the feedback communication based at least in part on using a TD-OCC scheme.
Aspect 26: The method of Aspect 25, wherein a first subset of the multiple partial interlace groups are associated with a PSFCH format 0 communication, and wherein a second subset of the multiple partial interlace groups are associated with a PSFCH format 2 communication.
Aspect 27: The method of any of Aspects 25-26, wherein the TD-OCC scheme is one of a two-level TD-OCC scheme or a four-level TD-OCC scheme.
Aspect 28: The method of any of Aspects 25-27, further comprising receiving a configuration of a resource pool associated with the feedback communication, wherein a size of the resource pool is based at least in part on a number of levels associated with the TD-OCC scheme.
Aspect 29: An apparatus for wireless communication at a device, comprising a processor; memory coupled with the processor; and instructions stored in the memory and executable by the processor to cause the apparatus to perform the method of one or more of Aspects 1-16.
Aspect 30: A device for wireless communication, comprising a memory and one or more processors coupled to the memory, the one or more processors configured to perform the method of one or more of Aspects 1-16.
Aspect 31: An apparatus for wireless communication, comprising at least one means for performing the method of one or more of Aspects 1-16.
Aspect 32: A non-transitory computer-readable medium storing code for wireless communication, the code comprising instructions executable by a processor to perform the method of one or more of Aspects 1-16.
Aspect 33: A non-transitory computer-readable medium storing a set of instructions for wireless communication, the set of instructions comprising one or more instructions that, when executed by one or more processors of a device, cause the device to perform the method of one or more of Aspects 1-16.
Aspect 34: An apparatus for wireless communication at a device, comprising a processor; memory coupled with the processor; and instructions stored in the memory and executable by the processor to cause the apparatus to perform the method of one or more of Aspects 17-24.
Aspect 35: A device for wireless communication, comprising a memory and one or more processors coupled to the memory, the one or more processors configured to perform the method of one or more of Aspects 17-24.
Aspect 36: An apparatus for wireless communication, comprising at least one means for performing the method of one or more of Aspects 17-24.
Aspect 37: A non-transitory computer-readable medium storing code for wireless communication, the code comprising instructions executable by a processor to perform the method of one or more of Aspects 17-24.
Aspect 38: A non-transitory computer-readable medium storing a set of instructions for wireless communication, the set of instructions comprising one or more instructions that, when executed by one or more processors of a device, cause the device to perform the method of one or more of Aspects 17-24.
Aspect 39: An apparatus for wireless communication at a device, comprising a processor; memory coupled with the processor; and instructions stored in the memory and executable by the processor to cause the apparatus to perform the method of one or more of Aspects 25-28
Aspect 40: A device for wireless communication, comprising a memory and one or more processors coupled to the memory, the one or more processors configured to perform the method of one or more of Aspects 25-28.
Aspect 41: An apparatus for wireless communication, comprising at least one means for performing the method of one or more of Aspects 25-28.
Aspect 42: A non-transitory computer-readable medium storing code for wireless communication, the code comprising instructions executable by a processor to perform the method of one or more of Aspects 25-28.
Aspect 43: A non-transitory computer-readable medium storing a set of instructions for wireless communication, the set of instructions comprising one or more instructions that, when executed by one or more processors of a device, cause the device to perform the method of one or more of Aspects 25-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a configuration of a feedback resource associated with a sidelink feedback channel, wherein the feedback resource is associated with an eight-level code division multiplexing (CDM) scheme; and
transmit a feedback communication associated with a sidelink data communication using the feedback resource, wherein transmitting the feedback communication is based at least in part on using the eight-level CDM scheme to generate the feedback communication.

2. The UE of claim 0, wherein the feedback communication is associated with a physical sidelink feedback channel format 2 communication.

3. The UE of claim 0, wherein the feedback resource spans multiple contiguous symbols within a slot.

4. The UE of claim 0, wherein a quantity of the multiple contiguous symbols is either preconfigured or indicated via a radio resource control communication and associated with a resource pool associated with the feedback communication.

5. The UE of claim 0, wherein the one or more processors are further configured to receive a configuration of a resource pool associated with the feedback communication, wherein a size of the resource pool is based at least in part on the eight-level CDM scheme.

6. The UE of claim 0, wherein the eight-level CDM scheme is associated with a time domain orthogonal cover code (TD-OCC) scheme and a frequency domain orthogonal cover code (FD-OCC) scheme.

7. The UE of claim 0, wherein the eight-level CDM scheme is associated with one of:
a two-level TD-OCC scheme and a four-level FD-OCC scheme, or
a four-level TD-OCC scheme and a two-level FD-OCC scheme.

8. The UE of claim 0, wherein the feedback communication includes demodulation reference signal (DMRS) information that is frequency division multiplexed with feedback information, and wherein the TD-OCC scheme and the FD-OCC scheme are applied to both the DMRS information and the feedback information.

9. The UE of claim 0, wherein the eight-level CDM scheme is associated with a first-step frequency domain orthogonal cover code (FD-OCC) scheme and a second-step FD-OCC scheme.

10. The UE of claim 0, wherein the first-step FD-OCC scheme is associated with a two-level FD-OCC scheme, and wherein the second-step FD-OCC scheme is associated with a four-level FD-OCC scheme.

11. The UE of claim 0, wherein the feedback communication includes demodulation reference signal (DMRS) information that is frequency division multiplexed with feedback information, wherein the first-step FD-OCC scheme and the second-step FD-OCC scheme are applied to the feedback information, and wherein a time domain orthogonal cover code (TD-OCC) scheme and another FD-OCC scheme are applied to the DMRS information.

12. The UE of claim 0, wherein the one or more processors are further configured to transmit the feedback communication using a scheduled interlace associated with the feedback resource, wherein the scheduled interlace is associated with multiple non-contiguous physical resource blocks (PRBs).

13. The UE of claim 0, wherein the eight-level CDM scheme is associated with a frequency division orthogonal cover code (FD-OCC) scheme, and wherein the feedback communication is transmitted using FD-OCC cycling such that an FD-OCC sequence changes between subsequent PRBs, of the multiple non-contiguous PRBs.

14. The UE of claim 0, wherein an FD-OCC sequence index associated with a corresponding FD-OCC sequence in a corresponding PRB, of the multiple non-contiguous PRBs, is determined based at least in part on an FD-OCC-cycling formula.

15. The UE of claim 0, wherein the FD-OCC-cycling formula is based at least in part on a length of the corresponding FD-OCC sequence and an initial FD-OCC sequence index.

16. The UE of claim 0, wherein the initial FD-OCC sequence index is at least one of:
indicated via a radio resource control communication,
based at least in part on a source identifier associated with the feedback resource,
based at least in part on a zone identifier associated with the feedback resource, or
indicated via a sidelink control information message.

17. A user equipment (UE) for wireless communication, comprising:
a memory; and
one or more processors, coupled to the memory, configured to:
receive a configuration of a feedback resource associated with a sidelink feedback channel, wherein the feedback resource is associated with multiple sub-physical-resource-block (sub-PRB) interlaces; and
transmit a feedback communication associated with a sidelink data communication using the feedback resource, wherein transmitting the feedback communication is based at least in part on transmitting feedback information in a sub-PRB interlace, of the multiple sub-PRB interlaces.

18. The UE of claim 0, wherein transmitting the feedback communication is further based at least in part on using eight-level code division multiplexing to generate the feedback communication.

19. The UE of claim 0, wherein the multiple sub-PRB interlaces include two sub-PRB interlaces within one PRB, wherein each sub-PRB interlace within the one PRB is associated with six contiguous resource elements.

20. The UE of claim 0, wherein transmitting the feedback communication is further based at least in part on using four-level code division multiplexing and four-level frequency division multiplexing to generate the feedback communication.

21. The UE of claim 0, wherein the multiple sub-PRB interlaces include four sub-PRB interlaces within one PRB, wherein each sub-PRB interlace within the one PRB is associated with three contiguous resource elements.

22. The UE of claim 0, wherein an indication of whether to implement sub-PRB interlacing is either preconfigured at the UE or indicated via a radio resource control communication.

23. The UE of claim 0, wherein the one or more processors are further configured to receive an indication of the sub-PRB interlace.

24. The UE of claim 0, wherein the one or more processors are further configured to map a sidelink data communication to the sub-PRB interlace.

25. A user equipment (UE) for wireless communication, comprising:
a memory; and
one or more processors, coupled to the memory, configured to:
receive a configuration of a feedback resource associated with a sidelink feedback channel, wherein the feedback resource is associated with multiple partial interlace groups; and
transmit a feedback communication associated with a sidelink data communication using the feedback resource, wherein transmitting the feedback communication is based at least in part on:
transmitting feedback information in a first partial interlace group, of the multiple partial interlace groups, and
generating the feedback communication based at least in part on using a time domain orthogonal cover code (TD-OCC) scheme.

26. The UE of claim 0, wherein a first subset of the multiple partial interlace groups are associated with a physical sidelink feedback channel (PSFCH) format 0 communication, and wherein a second subset of the multiple partial interlace groups are associated with a PSFCH format 2 communication.

27. The UE of claim 0, wherein the TD-OCC scheme is one of a two-level TD-OCC scheme or a four-level TD-OCC scheme.

28. The UE of claim 0, wherein the one or more processors are further configured to receive a configuration of a resource pool associated with the feedback communication, wherein a size of the resource pool is based at least in part on a number of levels associated with the TD-OCC scheme.

29. A method of wireless communication performed by a user equipment (UE), comprising:
receiving a configuration of a feedback resource associated with a sidelink feedback channel, wherein the feedback resource is associated with an eight-level code division multiplexing (CDM) scheme; and
transmitting a feedback communication associated with a sidelink data communication using the feedback resource, wherein transmitting the feedback communication is based at least in part on using the eight-level CDM scheme to generate the feedback communication.

30. The method of claim 29, wherein the eight-level CDM scheme is associated with a time domain orthogonal cover code (TD-OCC) scheme and a frequency domain orthogonal cover code (FD-OCC) scheme.

31. The method of claim 30, wherein the eight-level CDM scheme is associated with one of:
a two-level TD-OCC scheme and a four-level FD-OCC scheme, or
a four-level TD-OCC scheme and a two-level FD-OCC scheme.

32. The method of claim 30, wherein the feedback communication includes demodulation reference signal (DMRS) information that is frequency division multiplexed with feedback information, and wherein the TD-OCC scheme and the FD-OCC scheme are applied to both the DMRS information and the feedback information.

33. The method of claim 30, wherein the eight-level CDM scheme is associated with a first-step frequency domain orthogonal cover code (FD-OCC) scheme and a second-step FD-OCC scheme.

34. The method of claim 33, wherein the first-step FD-OCC scheme is associated with a two-level FD-OCC scheme, and wherein the second-step FD-OCC scheme is associated with a four-level FD-OCC scheme.

35. The method of claim 33, wherein the feedback communication includes demodulation reference signal (DMRS) information that is frequency division multiplexed with feedback information, wherein the first-step FD-OCC scheme and the second-step FD-OCC scheme are applied to the feedback information, and wherein a time domain orthogonal cover code (TD-OCC) scheme and another FD-OCC scheme are applied to the DMRS information.

36-40. (canceled)
